(19) United States
(12) Patent Application Publication
(10) Pub. No.: US 2020/0234204 A1
(43) Pub. Date: Jul. 23, 2020

(54) SYSTEM AND METHOD FOR CONSTRUCTION ESTIMATING

(71) Applicant: ProEst, Inc., San Diego, CA (US)

(72) Inventor: Jeffrey GERARDI, San Diego, CA (US)

(21) Appl. No.: 16/652,611

(22) PCT Filed: Oct. 2, 2018
(86) PCT No.: PCT/US2018/054036

§ 371 Date: Mar. 31, 2020

Related U.S. Application Data
(60) Provisional application No. 62/566,962, filed on Oct. 2, 2017.

(51) Int. Cl. G06Q 10/06; G06Q 50/08

(52) U.S. Cl. CPC G06Q 10/0633; G06Q 50/08; G06Q 10/063118

(57) ABSTRACT

A network based server system is provided that facilitates collaboration by a plurality of users to prepare a construction project estimate in accordance with an established workflow and assigned tasks that are carried out by the plurality of users that collaborate to prepare the construction project estimate. The established workflow may include various interdependent tasks and the construction project estimate is updated in real time based on current material and labor costs obtained from a local database or from a third party application device that provides real time material cost information.

### CROSS-REFERENCE TO RELATED APPLICATIONS

The present application claims priority to U.S. Provisional Patent Application No. 62/566,962, filed on Oct. 2, 2017, which is hereby incorporated herein by reference, as if set forth in full.

### BACKGROUND

### Field of the Invention

The present invention is generally related to the construction industry and is more specifically related to generating estimates for construction projects and management of the entire pre-construction sales process.

### Related Art

In the construction industry, the process of bidding a job is highly complex. Individual estimates for each element of a large project are required and often times separate companies (e.g., sub-contractors) each provide a separate estimate in separate formats. One significant problem with plural estimates in separate formats is consolidation of the plural estimates into a single project estimate.

Additionally, estimating a construction project within a single company is itself highly complex. Separate individuals with expertise in separate areas are typically required to generate separate estimates for their individual elements of the overall construction project estimate. For example, labor costs estimates and material cost estimates and the amount of labor needed and the amount of materials needed are often assigned to separate individuals. Moreover, when preparing an estimate of an individual element, the person assigned to the individual element typically uses a spreadsheet or a specific software tool to prepare the estimate for the individual element. However, many of the individual elements of an overall construction project estimate are dependent on other elements within the estimate. One problem with the significant interdependency of elements in preparation of a construction project estimate is the resulting inefficiency caused by having to redo certain elements of the construction project estimate when interdependent elements are revised.

Thus, the conventional systems and methods for preparing construction project estimates have created a need that remains unmet by the industry. Therefore, what is needed is a system and method that overcomes these significant problems found in the conventional systems as described above.

### SUMMARY

Described herein are solutions to the problems discussed above. In one embodiment a solution includes a system having a non-transitory computer readable medium configured to store executable programmed modules and a processor that is communicatively coupled with the non-transitory computer readable medium and the processor is configured to execute programmed modules stored therein. Stored in the non-transitory computer readable medium are modules including a user interface module, a workflow module, a tasks module, a costs module, a takeoffs module, an estimates module, a documents module, a reports module, an education module, a bid day module, and an integrations module. These modules are configured to be executed by the processor to carry out the functions of the system.

The user interface module is configured to present information and one or more user input fields on a display of a user device and the user interface module is further configured to receive information via the one or more user input fields. The workflow module is configured to control the scheduling of tasks associated with a project and further configured to control assignment of tasks to one or more users. The tasks module is configured to present one or more tasks to a user, wherein the one or more presented tasks have been assigned to the user. The costs module is configured to determine a cost associated with one or more items of material associated with the project and the costs module is further configured to determine a cost association with one or more items of labor associated with the project. The takeoffs module is configured to receive input from a user identifying an area of a scaled diagram associated with the project and calculate one or more metrics associated with the area of the scaled diagram. In one embodiment, the input from a user is a digital selection from a PDF file. The estimates module is configured to determine an estimated cost associated with at least a portion of a project, wherein the estimated cost comprises a materials cost portion and a labor cost portion.

The documents module is configured to receive and store one or more documents associated with the project and advantageously at least one of the one or more documents comprises a scaled diagram associated with the project. The reports module is configured to generate one or more reports associated with the project and present one or more reports on a display of a user device. The education module is configured to present information on a display of a user device, the presented information related to how to use one or more modules of the system. The bid day module is configured to compare two or more estimates for a specific portion of the project. The integrations module is configured to establish communication via a data communication network with a third party software application and receive information from the third party software application and provide information to the third party software application.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a network diagram illustrating an example system for construction project estimating according to an embodiment of the invention;

FIG. 2 is a block diagram illustrating an example construction project estimating server according to an embodiment of the invention;

FIGS. 3-25 are user interface diagrams illustrating example user interface screens in a system for construction project estimating according to an embodiment of the invention; and

FIG. 26 is a block diagram illustrating an example wired or wireless processor enabled device that may be used in connection with various embodiments described herein.

### DETAILED DESCRIPTION

Certain embodiments disclosed herein provide for a network based server that facilitates collaboration by a plurality of users to prepare a construction project estimate. For example, one method disclosed herein allows for establishing a workflow that implements a necessary order for preparation of estimates for interdependent elements of a construction project estimate and automatically updates a first interdependent element upon modification of a second interdependent element. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

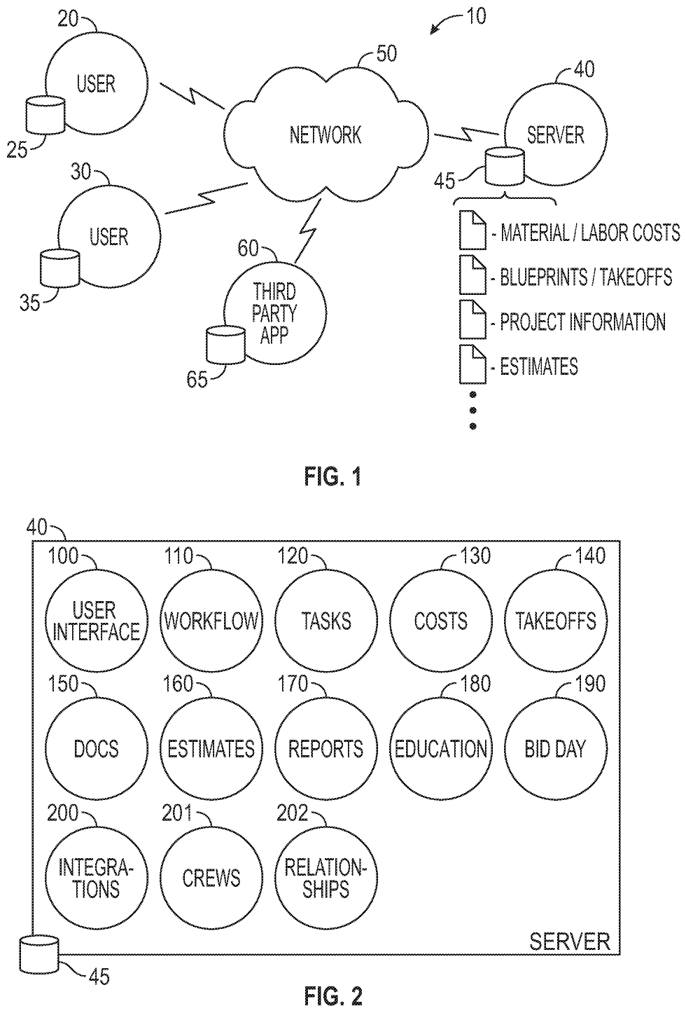

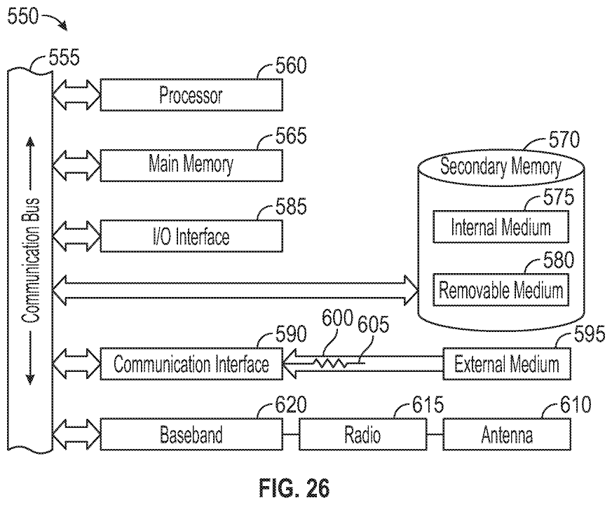

FIG. 1 is a network diagram illustrating an example system 10 for construction project estimating according to an embodiment of the invention. In the illustrated embodiment, the system 10 comprises one or more user interface devices 20 and 30 that are communicatively coupled with one or more server devices 40 via a data communication network 50. There may also be one or more third party application server devices 60 that host applications with which the server device 40 communicates via the network 50. The user devices 20 and 30 and the server device 40 and the third party application server device 60 are each configured with a data storage area 25, 35, 45 and 65, respectively. In various embodiments, the one or more user interface devices 20 and 30 and the server device 40 and third party application server device 60 may be implemented as wired or wireless communication devices such as the device described with respect to FIG. 26.

In operation, one or more users operate the user devices 20 and 30 and the server device 40 presents a user interface to the one or more uses on a display of the user devices 20 and 30. The one or more users interact with the user interface provided by the server device 40 and the server device 40 provides information to the one or more users via the user interface and the serer device 40 receives input from the one or more users via the user interface. The server device 40 hosts project information in its data storage area 45 and manages the workflow and tasks and related information associated with various projects. The server device 40 also communicates with one or more third party application devices 60 in order to provide information to and receive information from third party applications that are hosted by the one or more third party application devices 60.

FIG. 2 is a block diagram illustrating an example construction project estimating server 40 according to an embodiment of the invention. In the illustrated embodiment, the server 40 comprises a user interface module 100, a workflow module 110, a tasks module 120, a costs module 130, a takeoffs module 140, a documents module 150, an estimates module 160, a reports module 170, an education module 180, a bid day module 190, an integrations module 200, a crew module 201 and a relationship module 202.

The user interface module 100 is configured to present a user interface on a display of a user device such as previously described user device 20. The server 40 may also present a portion of the user interface 100 by way of speakers or tactile feedback modules on a tactile feedback capable device such as a wireless communication device. Accordingly, the user interface 100 provided by the user 40 is not limited to presentation of information on a display device, but also includes all forms of user interface methodologies such as visual, sound and touch, just to name a few.

The server 40 is also configured to receive input from a user via the user interface 100. In one embodiment, the server 40 is configured to provide a user interface with designated user input areas. For example, an input field may be provided on a portion of a user interface that is presented on a display of a user device 20 and the server device 40 receives input from a user via the input field. Alternatively or in combination, an input field may be provided in an aural interface of the user device 20 and the server device 40 receives input from a user via the input field, for example via a microphone of a user device 20. Alternatively or in combination, an input field may be provided in a tactile interface of the user device 20 and the server device 40 receives input from a user via the input field, for example via a touch interface of a user device 20. Advantageously, various forms of input can be received by the server device 40 via the user interface, regardless of the format of the user interface.

The workflow module 110 is configured to create a workflow for a project and the workflow module 110 is also configured to manage the workflow associated with the project. For example, the workflow module 110 is configured to allow a user with appropriate privileges to create tasks associated with the project and assign tasks to one or more users. The workflow module 110 is also configure to allow a user with appropriate privileges to make certain tasks dependent on one or more other tasks in order to create and enforce a chronological task order for the project.

In operation, the workflow module 110 allows a user with appropriate privileges to create and schedule and enforce completion of all tasks associated with a project. The workflow module 110 is also configured to remind users of assigned tasks that not started or partially complete and the workflow module 110 may also require a user to complete a specific task before allowing the user to work on another task. The workflow module is also configured to present reminders to one or more users to facilitate timely completion of tasks by each of the users associated with the project and thereby the workflow module 110 is configured to manage the overall project time schedule.

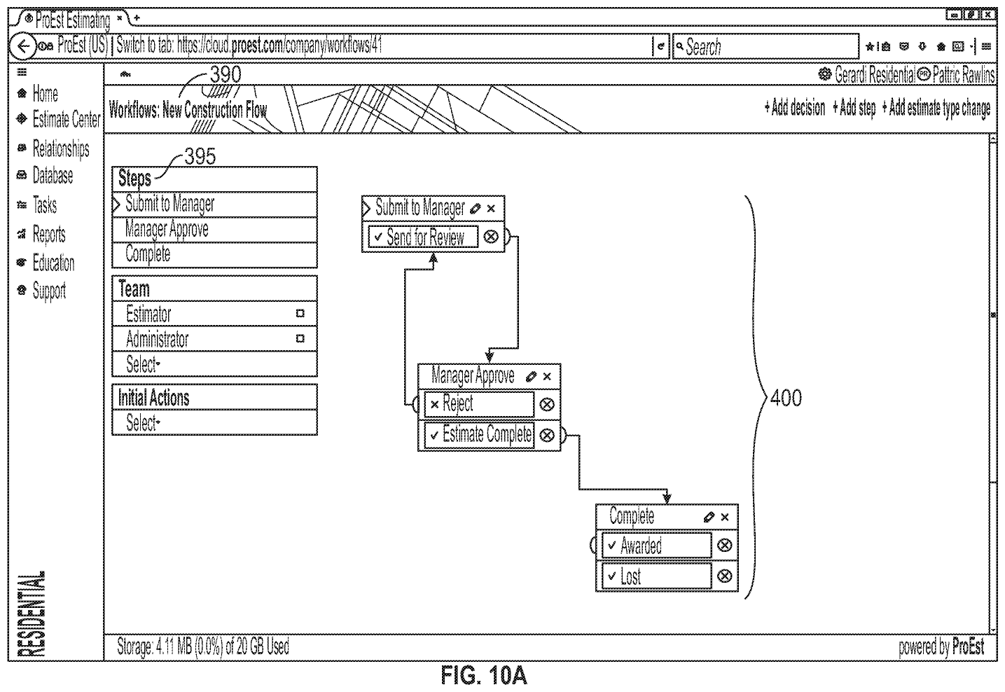

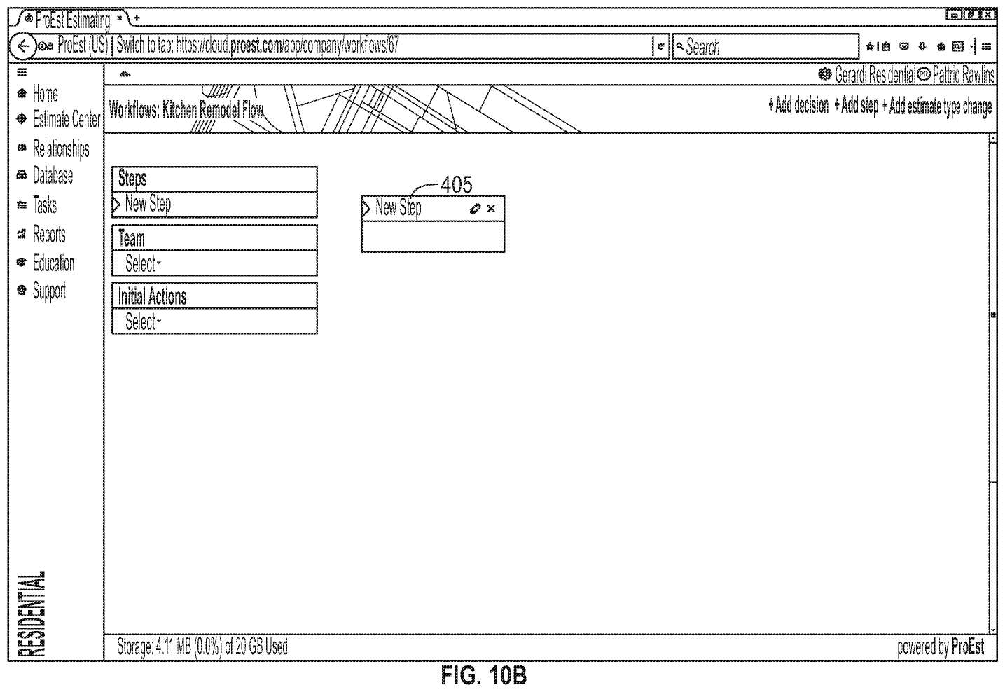

In one embodiment, the workflow module 110 is configured to cooperate with the user interface module 100 to present a visual representation of tasks and their interdependencies on a display of a user device, for example as shown in FIG. 10A. Advantageously, the user interface module 110 may receive input that causes the workflow module to create new interdependencies or modify existing interdependencies between the various tasks of a project. For example, interdependencies may define the next task to be completed upon acceptance or rejection of a current task.

The tasks module 120 is configured to manage a list of tasks that are assigned to a user and cooperate with the user interface module 100 to present a list of tasks to a user that is responsible for completing those tasks. The tasks module 120 is also configured to allow a user with appropriate rights to create new tasks and assign those tasks to other users. The tasks module 120 is also configured to allow a user with appropriate rights to view the status of existing tasks assigned to other users and re-assign existing tasks and/or update the parameters of existing tasks. The tasks module 120 is also configured to cooperate with the workflow module 110 to facilitate the proper order of tasks to be completed based on any interdependencies assigned by the workflow module 110.

The costs module 130 is configured to associate a unit cost with various elements of a project. Broadly speaking, the various elements may include labor elements and materials elements. More specifically, labor elements may advantageously be broken down by type of labor, for example, by trade or by the particular hourly rates for a specific company or individual. Similarly, materials elements may advantageously be broken down by the particular type of material (e.g., sheet rock, gravel, cement) and/or the particular type of material from a particular manufacturer.

The costs module 130 is configured to manage one or more standard costs lists and store the one or more standard costs lists in the data storage area 45. The costs module is also configured to allow a user with appropriate privileges to customize one or more costs lists and store the customized costs lists in the data storage area 45. Advantageously, customized costs lists may use a standard costs list as a starting point and change one or more items as desired.

The costs module 130 is also configured to associate one or more costs lists with a project. Advantageously, the one or more costs lists associated with a project may include standard costs lists and custom costs lists. In one embodiment, alternative costs lists may be associated with a project in order to prepare and compare alternative estimates based on the use of alternative labor providers or alternative material providers.

In one embodiment, the costs module 130 is configured to work cooperatively with the integrations module 200 to obtain real time pricing information from a provider of materials or labor. For example, the costs module 130 may periodically request a current cost per sheet of sheet rock and update one or more costs lists (e.g., the standard costs lists and one or more custom costs lists) with the current cost per sheet of sheet rock.

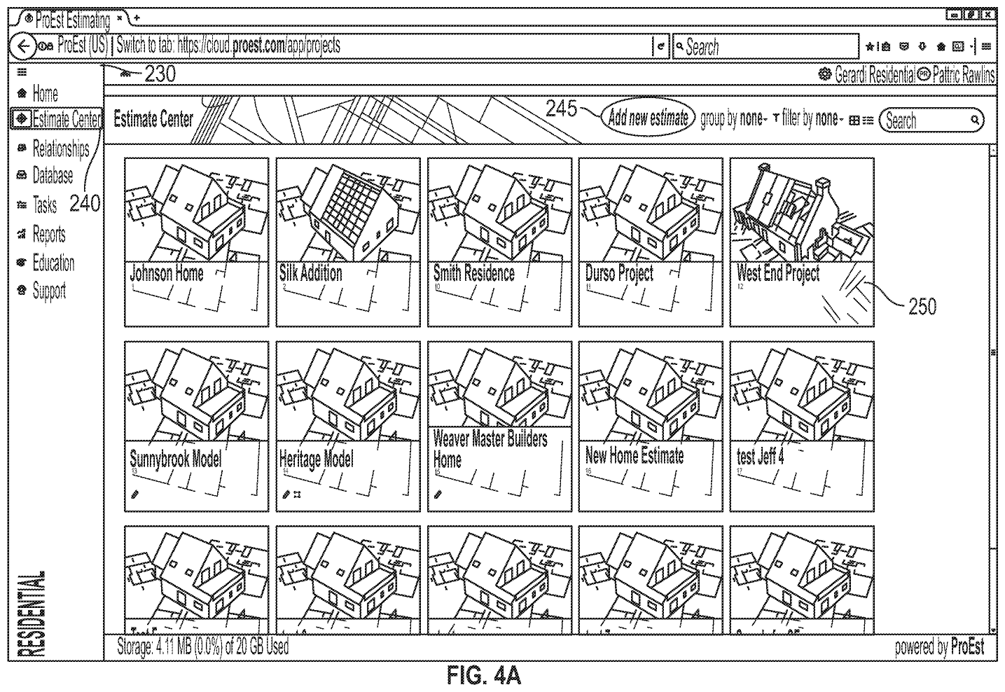

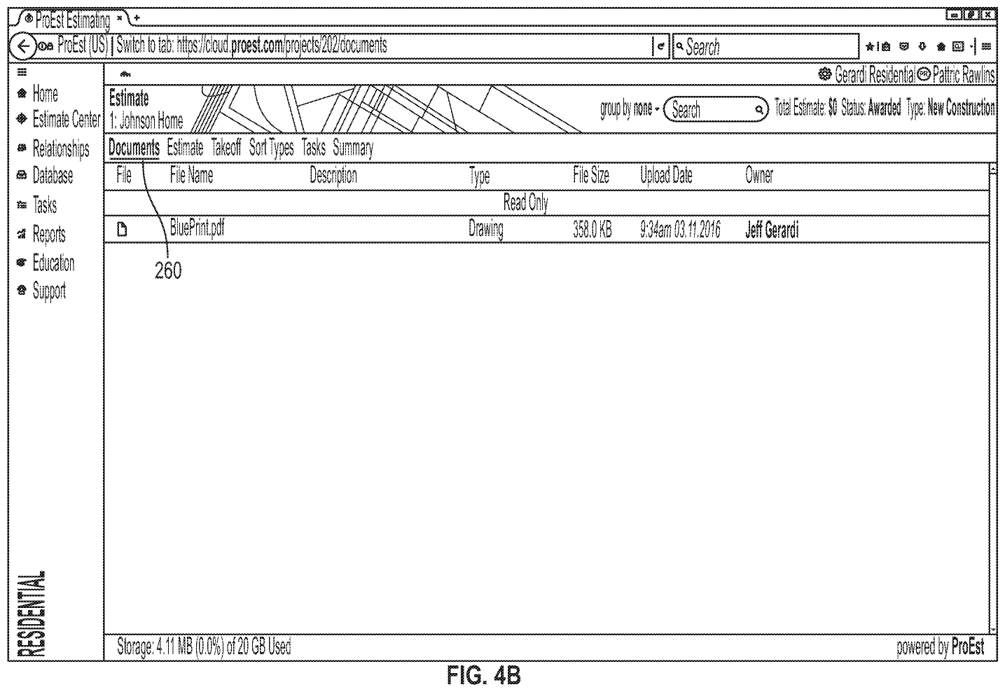

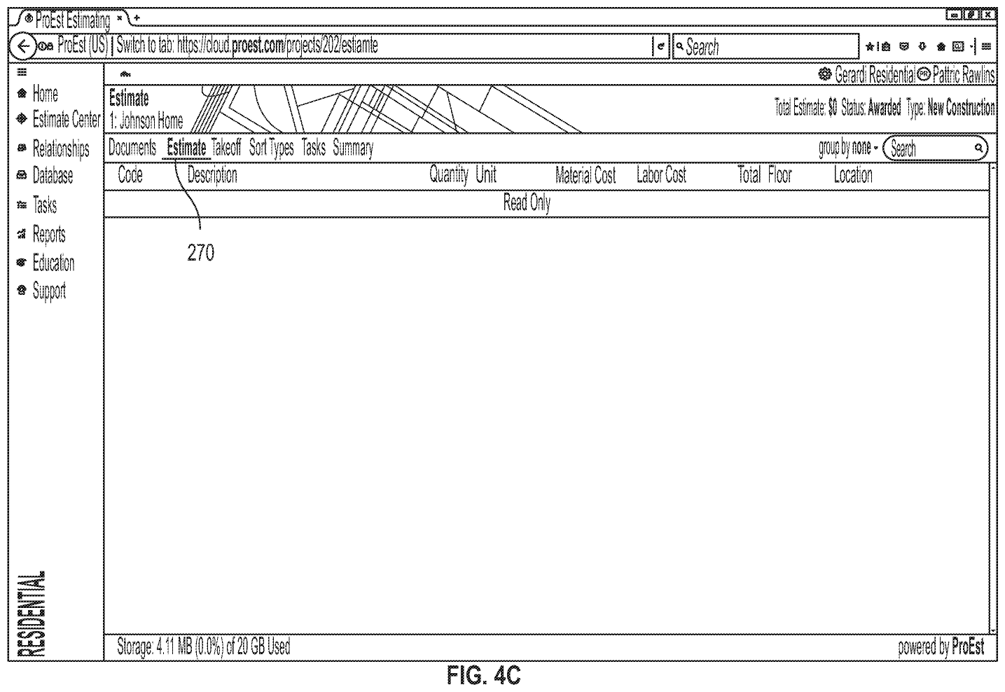

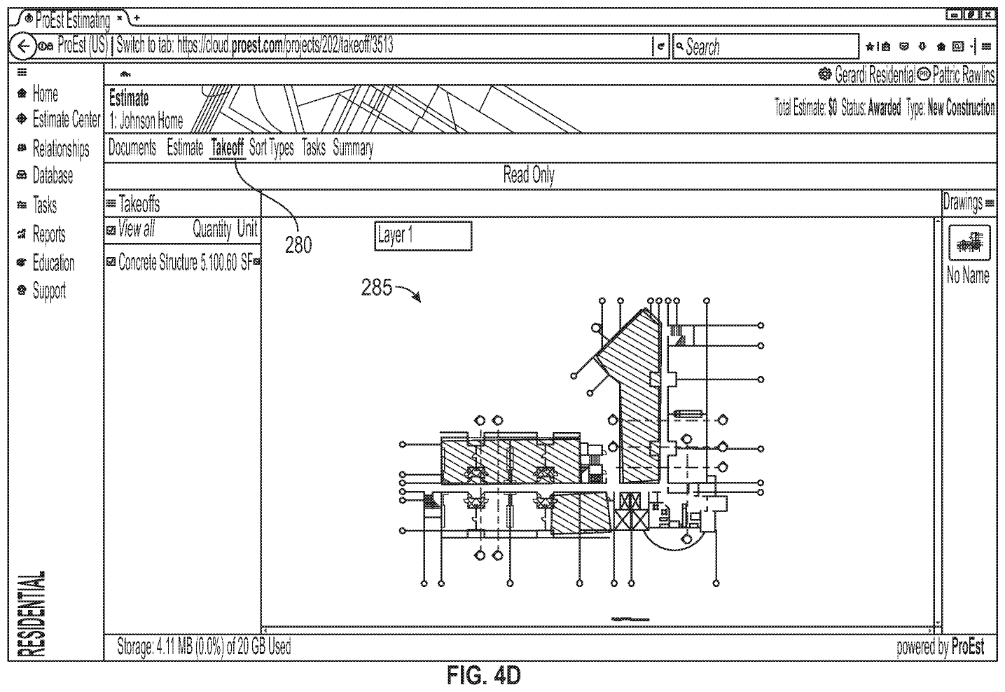

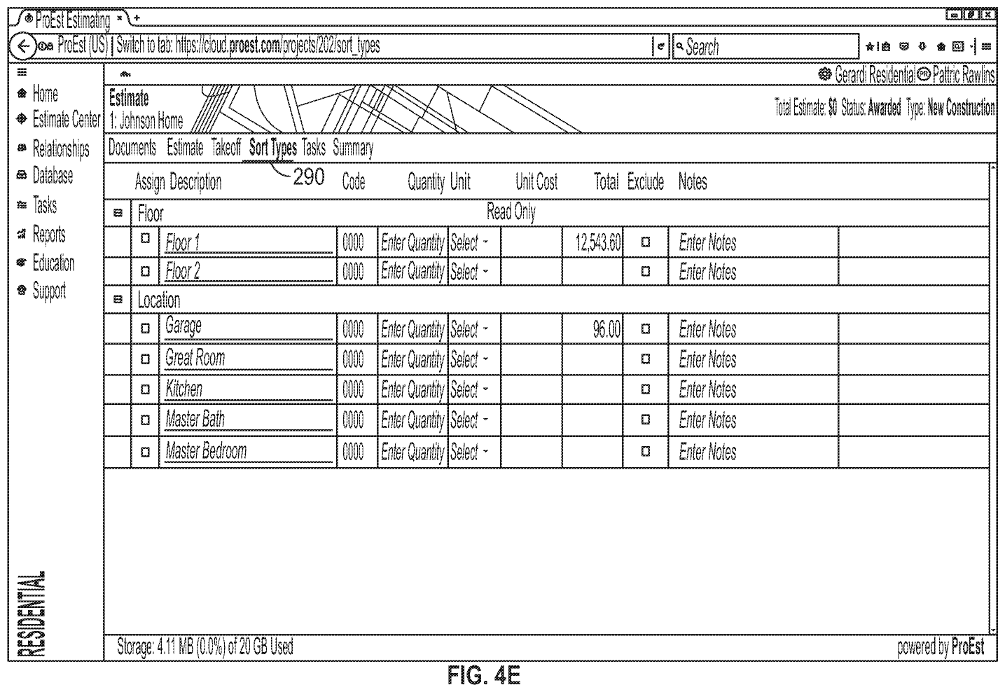

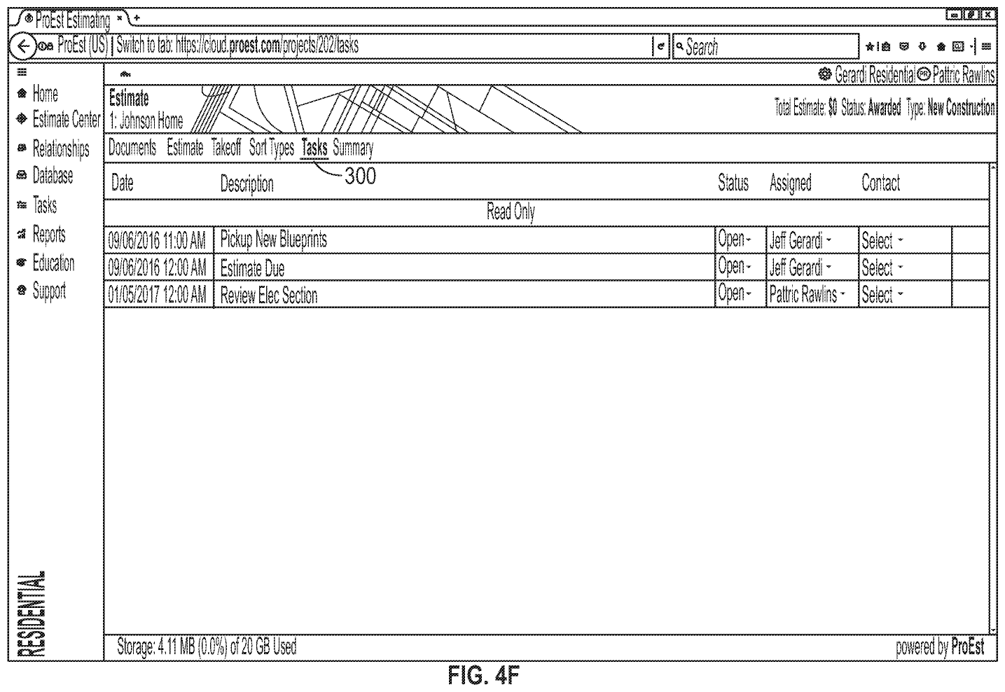

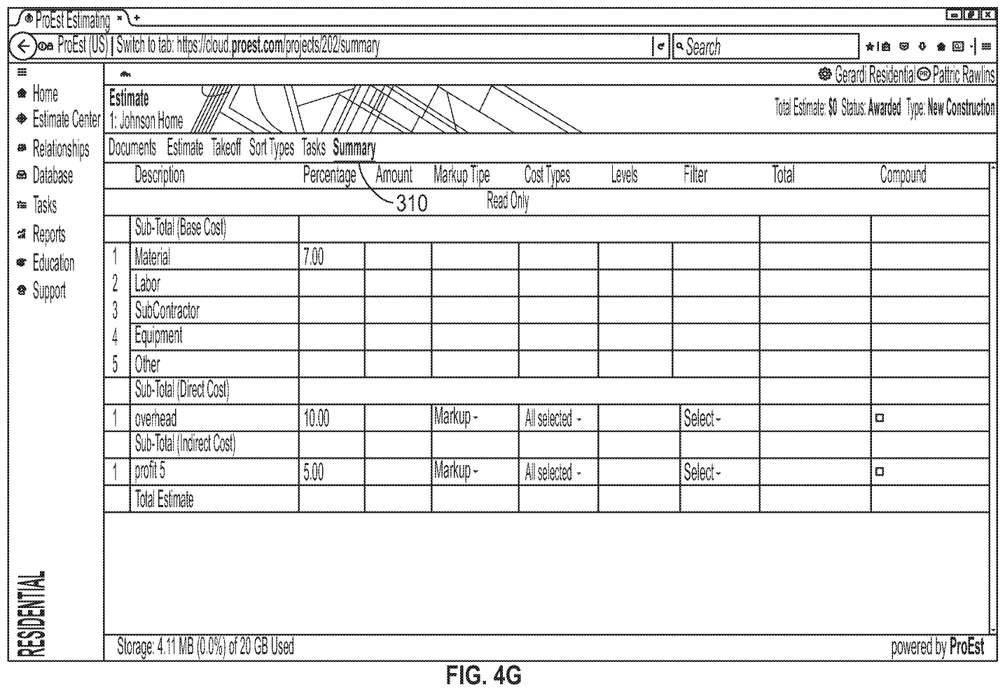

The takeoffs module 140 is configured to cooperate with the user interface module 100 to present a scaled diagram associated with the project to a user with appropriate privileges and receive input from the user to identify a discrete portion of the scaled diagram for measurement in accordance with the scale. A discrete portion may be an area or it may be linear feet or some other appropriate measurement such as a volume. For example, as shown in FIG. 4D, the takeoffs module 140 presents a scaled diagram and receives input identifying three separate areas to determine, e.g., a number of square feet of flooring material that is needed. In turn, based on the number of square feet of flooring material that is needed, the costs module 130 may determine the material cost for the flooring material and also the labor cost for installing the flooring material in the selected discrete portions of the scaled diagram. Advantageously, if the area of a discrete portion is updated by the takeoffs module 140, the system stores the updated area information and that updated area information is automatically used to also update the corresponding costs information. Advantageously, this results in up-to-date and accurate cost estimates for the individual elements of a project in real time.

The documents module 150 is configured to facilitate the uploading and storing of documents associated with one or more projects in the data storage area 45. In one embodiment, the documents module 150 allows a user with appropriate privileges to upload a custom costs document that can be processed by the costs module 130 to prepare a custom costs list. Similarly, scaled diagrams can also be uploaded by the documents module 150 and stored in the data storage area 45 and associated with one or more projects.

The estimates module 160 is configured to prepare estimates associated with a project or with a portion of a project. An estimate may include cost estimates that include both labor and material costs. In one embodiment, the estimates module 160 is configured to provide an estimate for an entire project and/or an estimate for a portion of a project. For example, the estimates module 160 may provide a total project estimate for construction of a multi-floor office building and the estimates module 160 may also provide a partial project estimate for only a single floor of the multi-floor office building.

Advantageously, the estimates module 160 can provide real time updates to any estimate based on any updates to the underlying elements of the project. For example, if there is a material cost change or a labor cost change or an amount of material change, the estimates module 160 advantageously automatically updates the estimated project cost based on the update to the underlying element. In one embodiment, when a multi-floor office building project is updated to add an additional floor or to remove an existing floor, the estimates module 160 is configured to automatically update the overall project estimate and/or automatically update the estimate for a portion of the project such as a single floor.

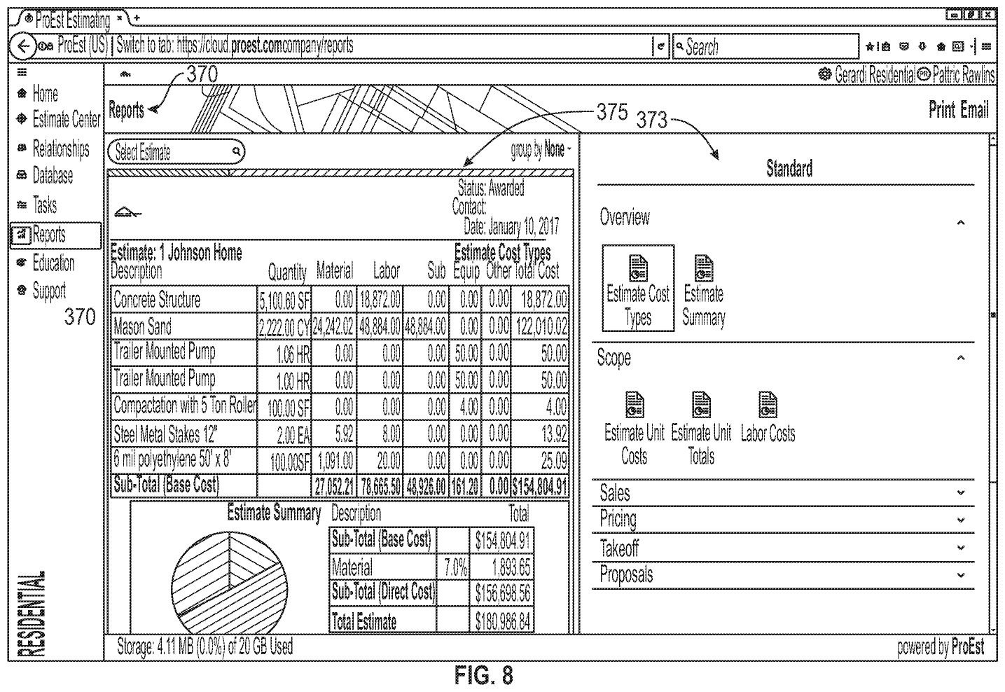

The reports module 170 is configured to generate one or more reports about various aspects of the system and about groups of projects or individual projects or portions of groups of projects or portions of individual projects. In one embodiment, the reports module 170 is configured to cooperate with the user interface module 100 to present a split screen user interface that presents a list of available reports in a first portion and the substance of a selected report in a second portion, for example as shown in FIG. 8. The reports module 170 is also configured to allow users to design and save custom reports for use at any time.

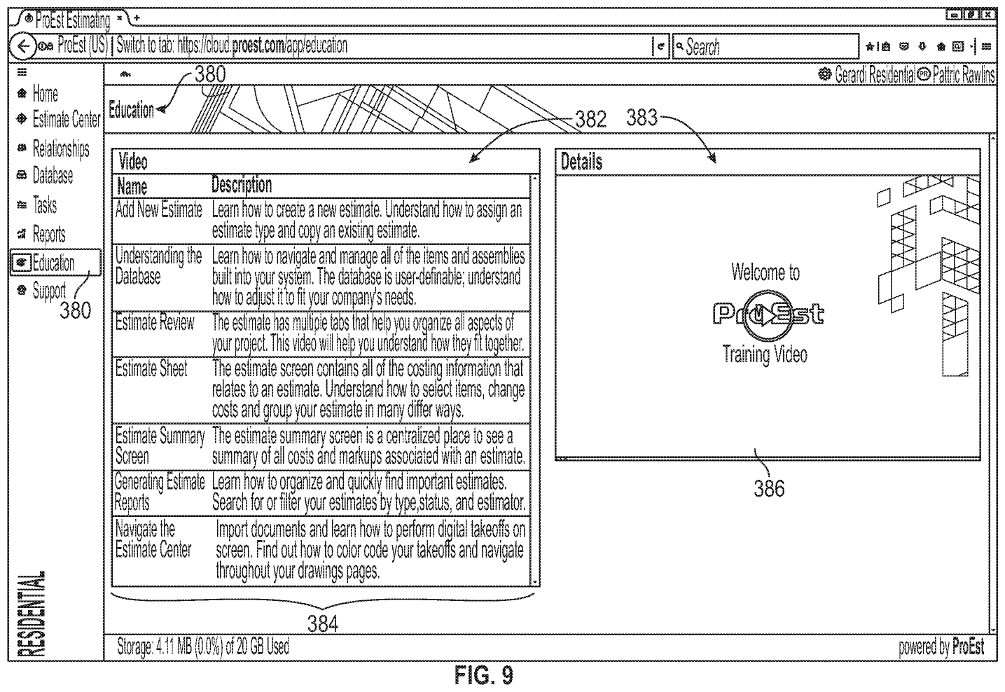

The education module 180 is configured to cooperate with the user interface module 100 to present information to a user related to how to use the system. In one embodiment, the information presented to a user is presented in form of a video, which may also include an audio component. In one embodiment, the education module 180 is configured to cooperate with the user interface module 100 to present a split screen user interface that presents a list of available educational materials in a first portion and the visual substance of a selected education material in a second portion, for example as shown in FIG. 9.

The bid day module 190 is configured to analyze and compare multiple estimates for the same portion of a project. For example, an owner or project manager or general contractor user may receive multiple estimates from multiple sub-contractor users for the same portion of the overall project being implemented by the owner or project manager or general contractor. In one embodiment, multiple electrical sub-contractors may submit estimates for the electrical portion of a project. Advantageously, the bid day module 190 analyzes each of the multiple estimates for the electrical portion of the project and compares the estimates. In one embodiment, the bid day module 190 may generate a comparison report that emphasizes the similarities and/or differences between the multiple estimates for the electrical portion of a project.

The bid day module 190 is also configured to simplify the bid management process by managing all bids that are associated with a project. For example, the bid day module 190 is configured to manage all subcontractor bids and material bids and services bids for a project. Advantageously, the bid day module 190 is also configured to coordinate the receipt of bid submissions associated with a project. For example, the system maintains a list of subcontractors and material vendors and when a particular subcontractor or material vendor is selected for a particular project, the bid day module 190, at an appropriate time, sends an invitation (e.g., by way of a digital communication such as an email or text message) to solicit the subcontractor or material vendor to submit a bid or a quote on a particular section of the project. The bid day module 190 advantageously allows the user to can see all of the invitations that were sent for a particular project or section of a project and who has responded with a confirmation of an intent to bid, an actual bid, or who has not responded at all.

The integrations module 200 is configured to integrate the server 40 with one or more third party application devices 60. In one embodiment, the integrations module 200 comprises a plurality of programmed interfaces that are each customized to integrate the server 40 with a specific third party application device 60. In operation, the server 40 requests to send or receive information to or from a specific third party application device 60 and the appropriate programmed interface is configured to contact the specific third party application device 60 via a data communication network and provide or receive information to or from the specific third party application device 60. Advantageously, third party applications like Quickbooks or other accounting utilities and/or ProCore or other construction project management utilities.

The crew module 201 is configured to assemble a team that will perform a particular type of work. A crew may include a plurality of individual users and items. For example, a crew may include a first user that is a carpenter and a second user that is an electrician and a third user that is a foreman. The crew may also include a first item that is a bulldozer and a second item that is a crane. Advantageously, the various users and items may work independently or cooperatively to perform the same or different tasks within the system. For example, a user that is a bull dozer operator and an item that is a bull dozer may work cooperatively to perform a task associated with a project. The crew module 201 is advantageously configured to assembly a crew and then calculate the labor and equipment costs associated with the crew performing various tasks on a project. The crew module 201 may also calculate labor and equipment costs per hour for a project. In one embodiment, the crew module 201 uses a productivity factor to calculate labor and equipment costs for a crew working on a project.

The relationship module 202 is configured to store and analyze information related to users of the system. The relationship module 202 is configured to perform a customer relationship management function. The relationship module 202 is configured to manage and analyze user interactions and data throughout the user lifecycle, with the goal of improving business relationships with users, assisting in user retention and driving sales growth. The relationship module 202 is also configured to compile information related to a user which may include a user's company website, telephone, live chat logs, direct mail sent, marketing materials and social media usage. The relationship module 202 is also configured to generate user facing information like the number of estimates created and the success rate or number of awarded jobs per user.

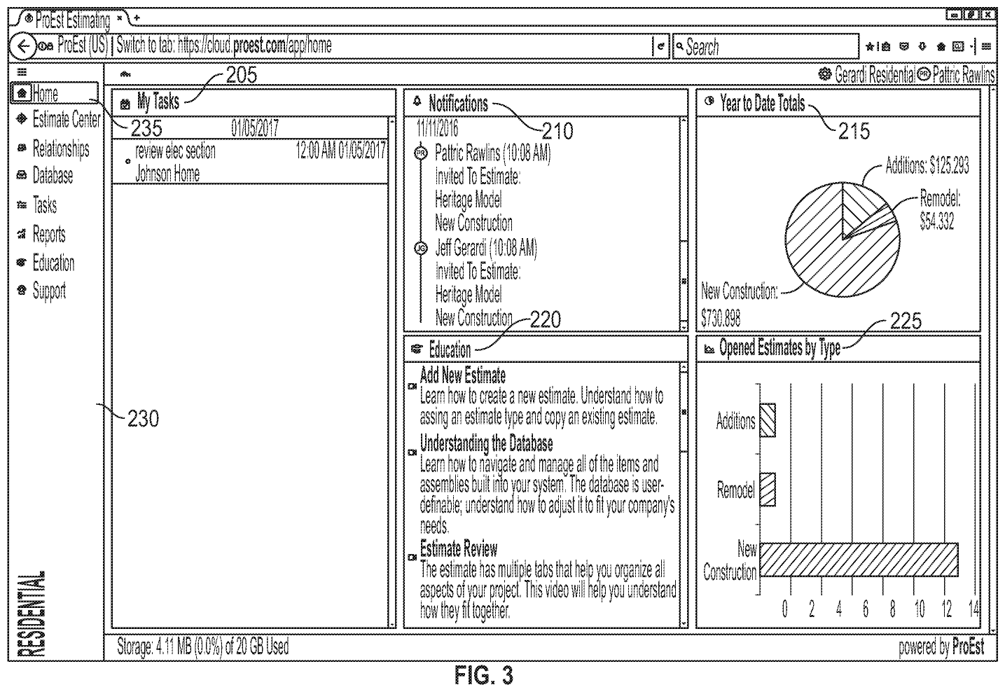

FIGS. 3-25 are user interface diagrams illustrating example user interface screens in a system for construction project estimating according to an embodiment of the invention.

FIG. 3 shows a home screen 235 for a user of the server 40. In one embodiment, the home screen 235 shows a current task list 205 for the particular user along with other helpful information such as a list of available educational materials 220 and any notifications 210 that have been directed to the particular user. Graphical information such as year to date totals 215 and opened estimates by type 225 can also be presented on the home screen. A navigation menu 230 may also be provided.

FIGS. 4A through 4G show various estimate center 240 user interface screens of an estimate module 160. In one embodiment, the estimates module 160 may encompass various other modules. As shown in FIG. 4A, a user is presented with a set of available projects such as project 250 to which the user is assigned and the user is also able to add a new estimate using a new estimate action 245 within the estimate module 160. When a specific estimate project is selected, a list of the various documents 260 associated with the selected estimate project are presented to the user, as shown in FIG. 4B. New documents can also be uploaded to the server 40. In FIG. 4C real time estimates 270 are shown using the most up-to-date information about the project. In one embodiment, if the user had previously requested an estimate, e.g., for a single floor in a multi-floor building project, or for lumber materials or for sheet rock material, etc., a real time estimate for the portion of the project is displayed in FIG. 4C. Advantageously, if the material or labor cost associated with any estimate has changed from when the estimate window was last visited, the updated real time estimate is presented upon the next visit to the estimate window.

FIG. 4D shows a takeoff window 280 that allows a user to identify a portion of a schematic drawing 285 for measurement by the server 40. Advantageously, portions of a schematic drawing 285 can be measured according to a scale on the schematic drawing 285 and a portion can be measured, for example, in linear distance, area, or volume. Various units of measurement can be used in various embodiments.

FIG. 4E shows various estimates for a project that are sorted by types 290 In this view, estimates for different floors (e.g., Floor 1 and Floor 2) and for different locations (e.g., Garage, Great Room, Kitchen, Master Bath and Master Bedroom) are presented by the estimates module 160.

FIG. 4F shows the various tasks 300 that are associated with preparing an estimate. For example, in the illustrated embodiment, a list of the tasks 300 corresponding to the selected estimate are shown, such as pickup new blueprints, estimate due and review electrical.

FIG. 4G shows an estimate summary 310 view where different portions of a project are grouped together with sub-totals that are added up to a total estimate amount at the bottom of the estimate summary 310.

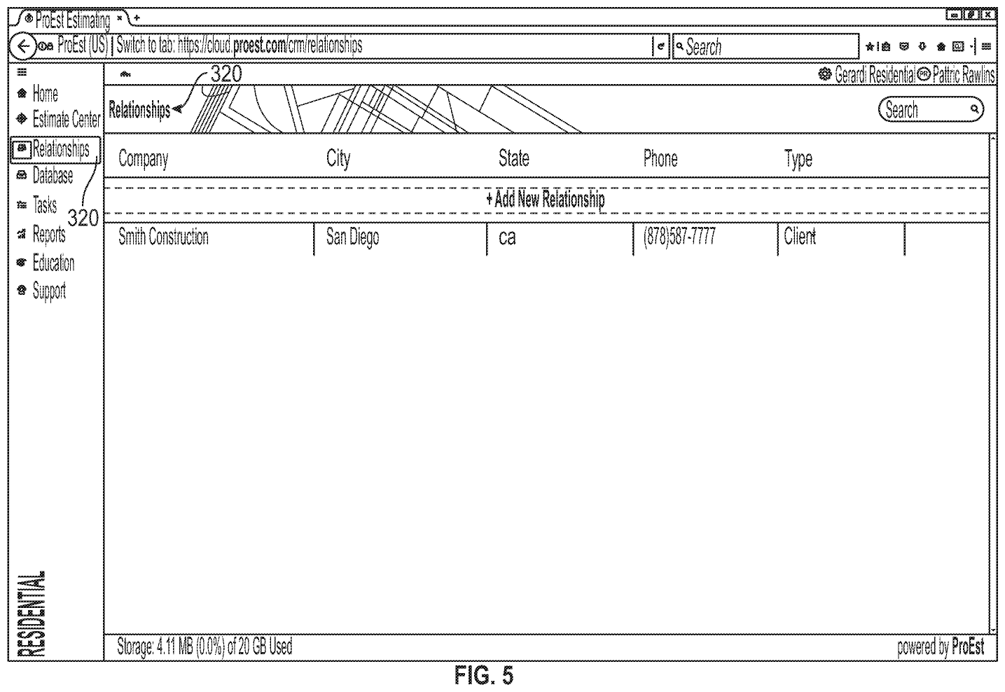

FIG. 5 shows a relationships 320 view that lists one or more individuals or companies with which a relationship exits. Advantageously, the relationships 320 view allows a user to add new relationships and/or edit existing relationships.

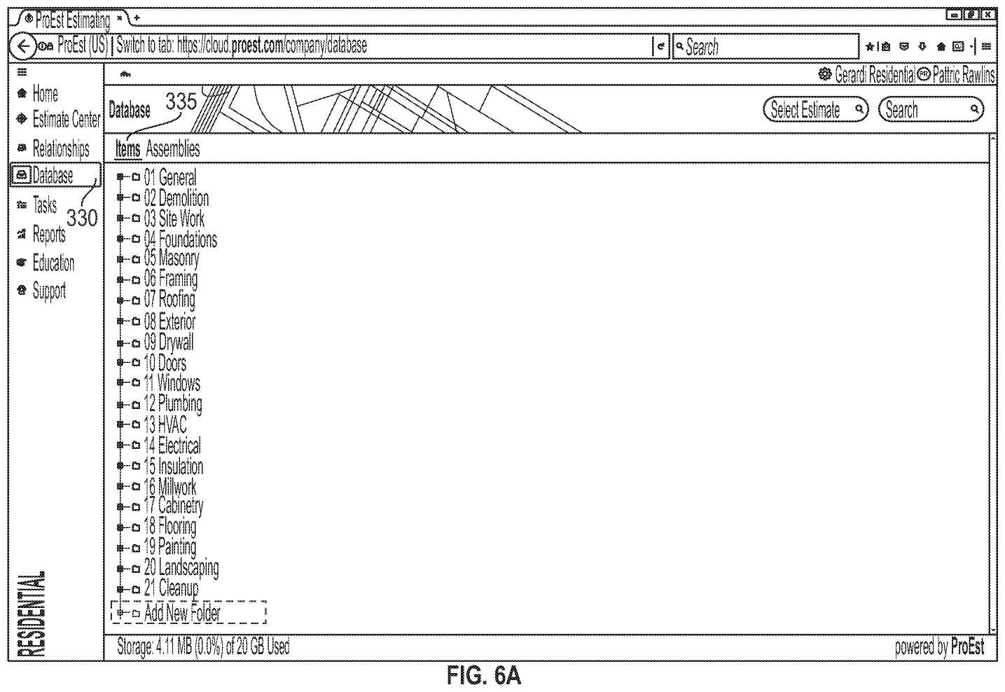

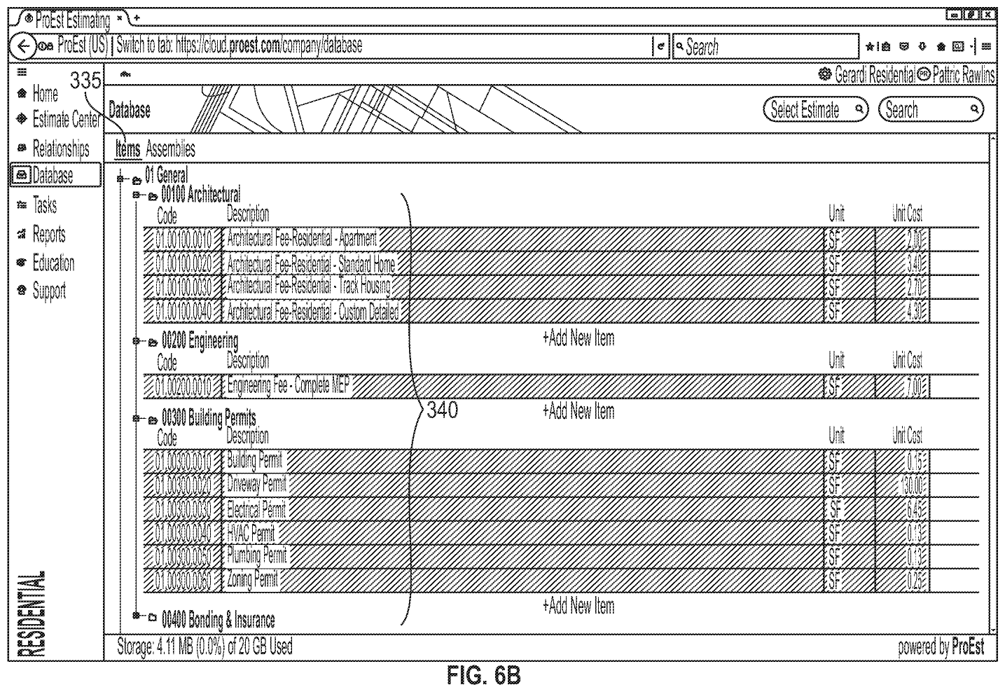

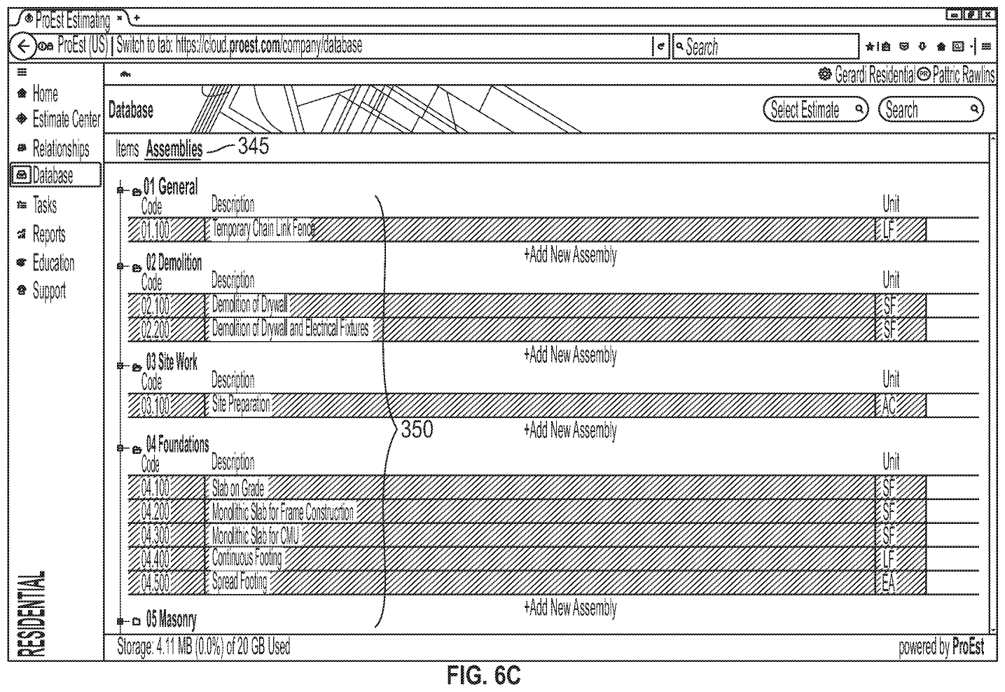

FIGS. 6A through 6C show various databases 330 views. As previously discussed, the server 40 allows a user to access standard databases of items 335 including information (e.g., standard costs) and a user may also create custom databases of items 335. Standard and custom databases may include costs of materials and labor. In one embodiment, the integrations module 200 is configured to access a third party application device 60 and obtain updated cost information for materials and update a corresponding database of materials with the updated cost information. In one embodiment, a database 330 may include a set of items 335 categorized into item types 340 that each include a unique code, a description, a unit designation, and a unit cost as shown in FIG. 6B. Similarly, in one embodiment, a database 330 may include a set of assemblies 345 categorized into assembly types 350 that each include a unique code, a description, and a unit designation as shown in FIG. 6C. In one embodiment, an assembly type 350 may also include a unit cost.

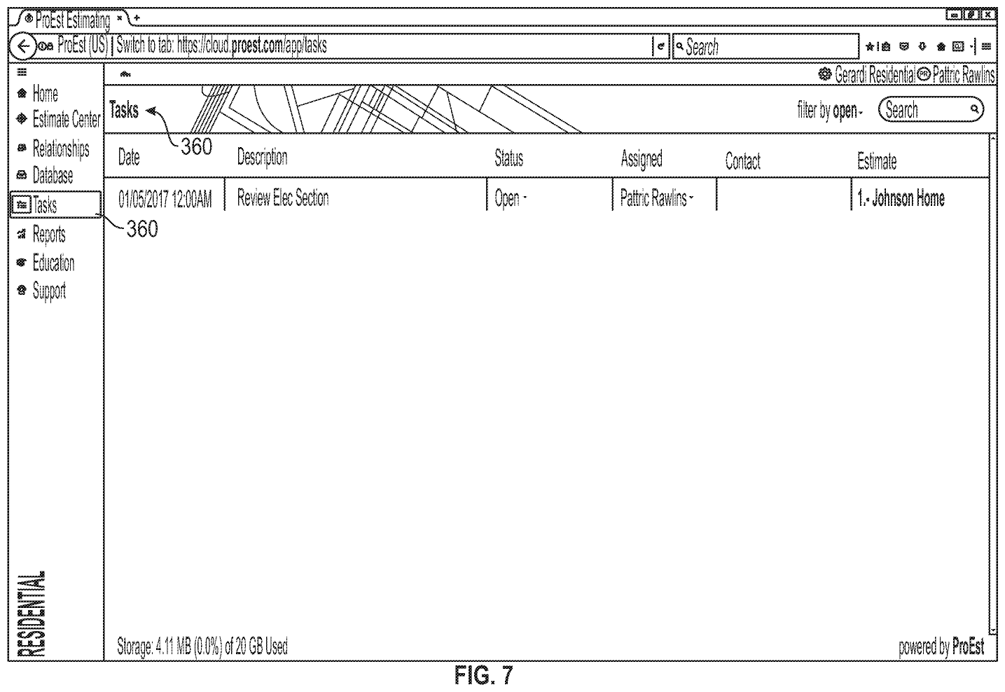

FIG. 7 shows a tasks 360 view that lists the various tasks associated with a user. FIG. 8 shows a reports 370 view that includes split screen having various reports that can be selected in a first portion 373 of the view and the substance of a selected report in a second portion 375 of the view. FIG. 9 shows an education 380 view that includes split screen having various educational materials 384 that can be selected in a first portion 382 of the view and the substance 386 of a selected educational material in a second portion 383 of the view.

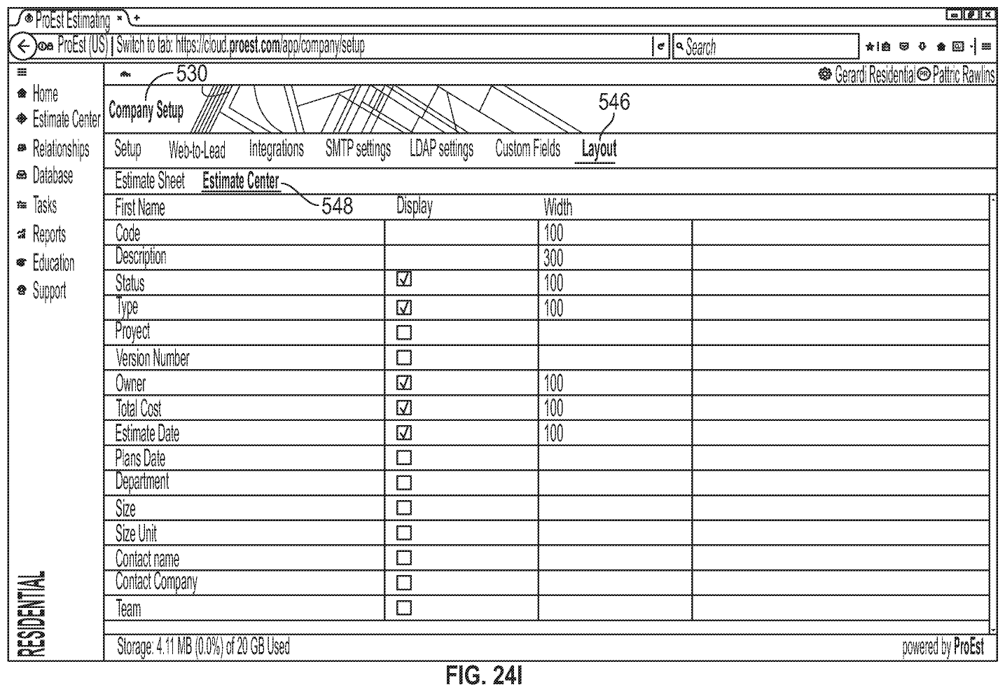

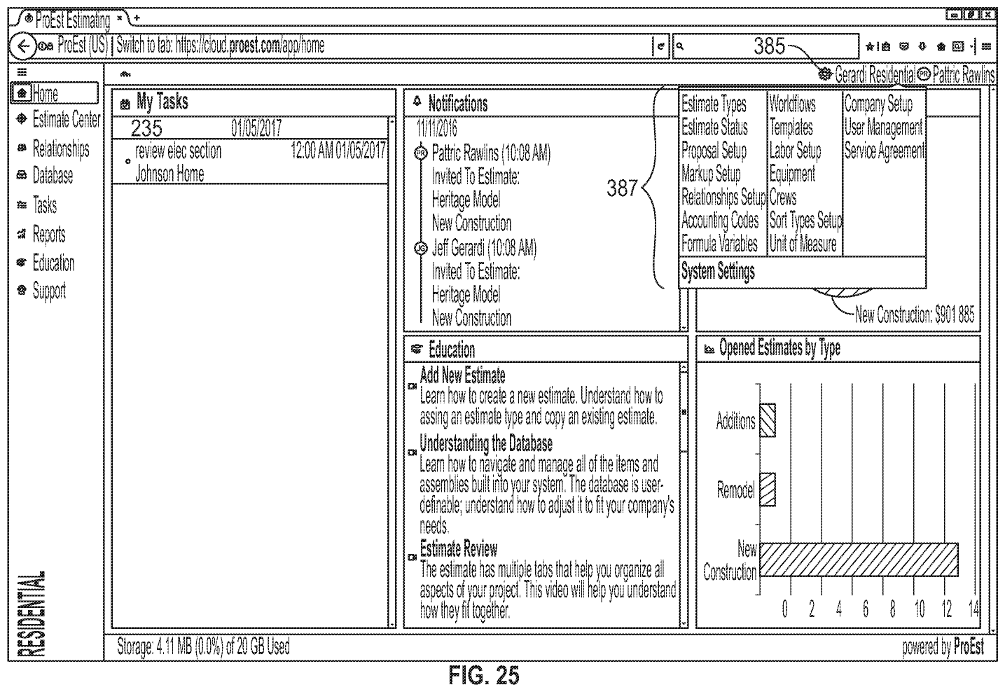

Turning now to FIG. 25, in the illustrated embodiment a home view is shown having a project 385 view that illustrates various settings 387 views provided by the server 40. Each of the various settings 387 views will now be described.

FIGS. 10A and 10B show workflow 390 views that allow a user to view existing workflows, edit existing workflows, and create new workflows. In the illustrated embodiments, the various steps 395 of a workflow are presented and a graphical illustration 400 of the workflow is also presented. Editing and existing workflow or creating a new workflow may include adding a new step 405.

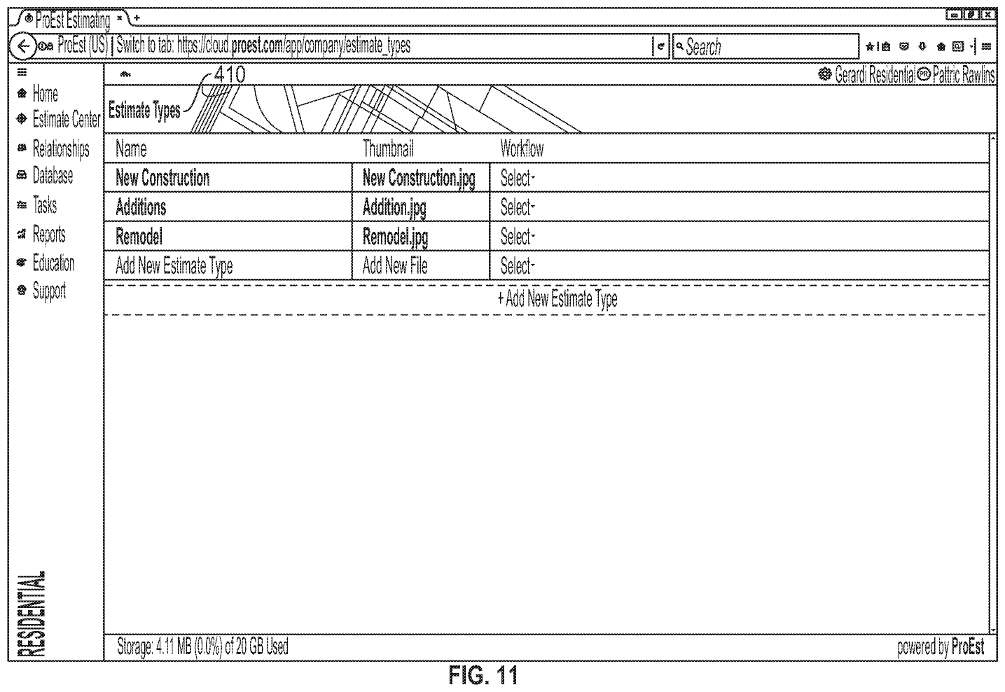

FIG. 11 shows an estimate types 410 view that allows a user to create various types of estimates and associate one or more workflows with each estimate type.

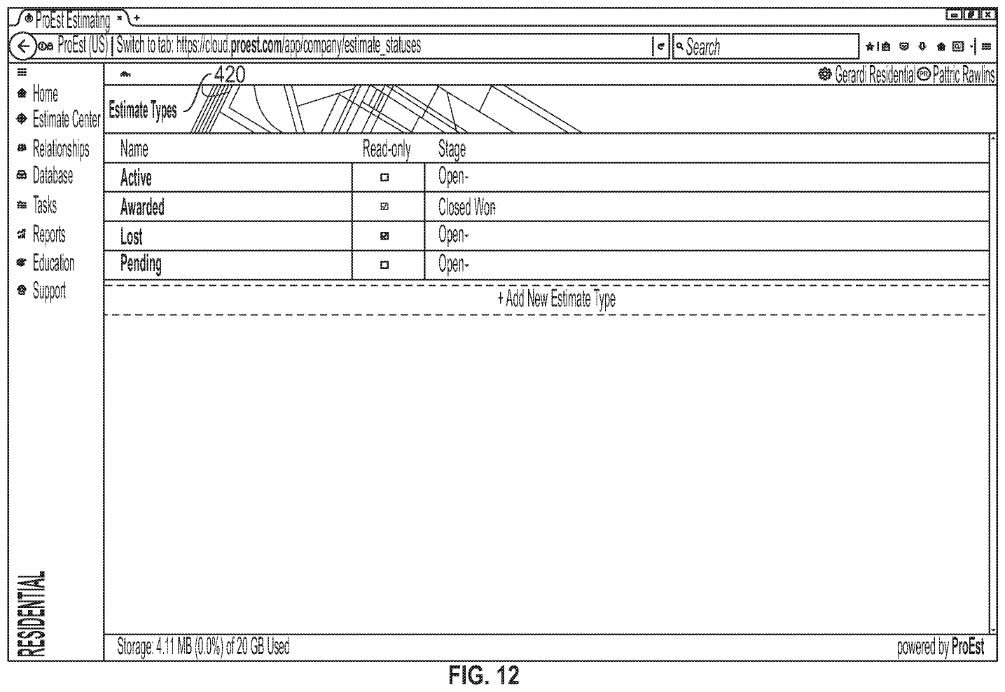

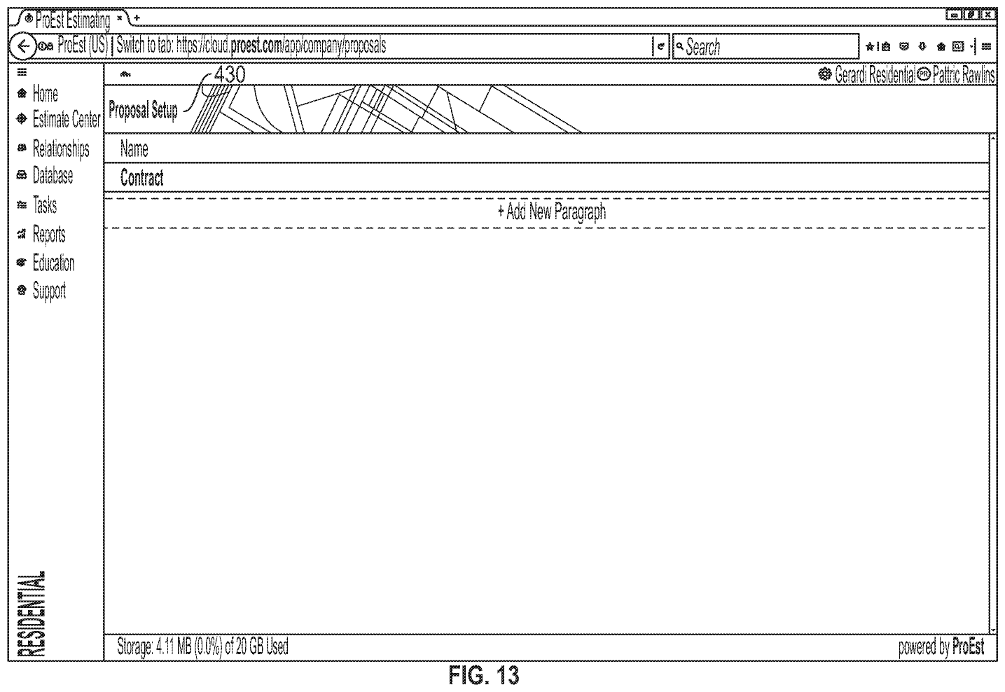

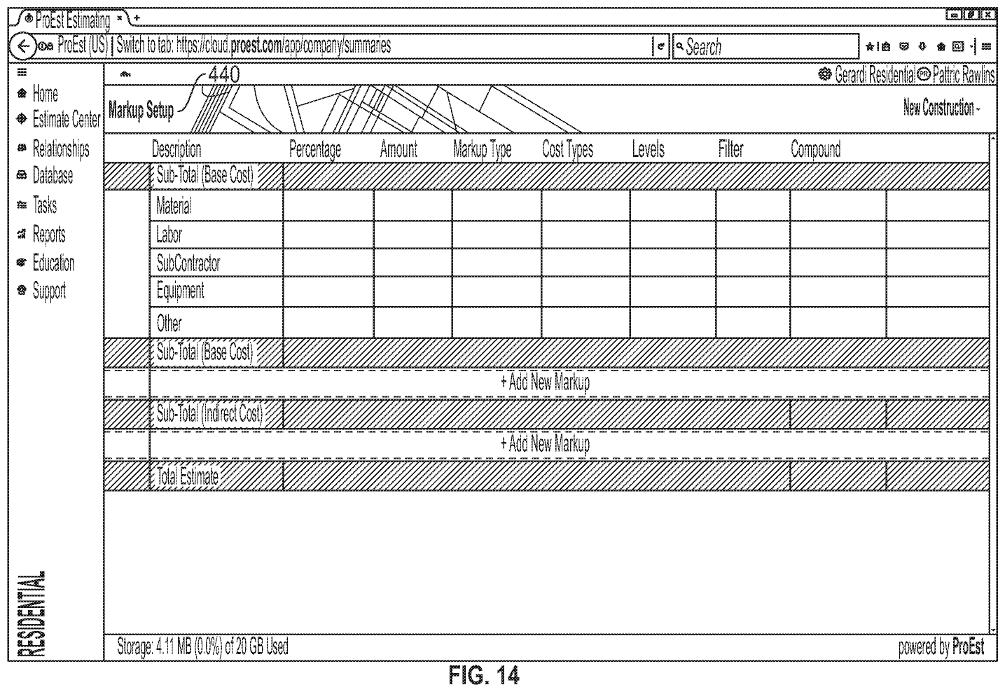

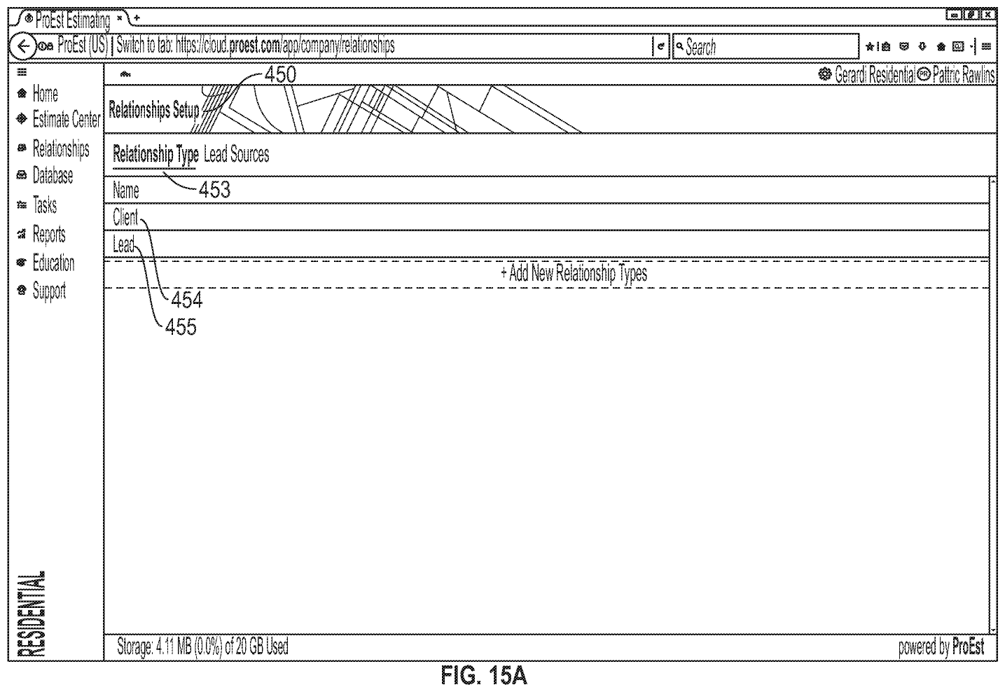

FIG. 12 shows an estimate status 420 view that shows a summary of the active, awarded, lost and pending estimate projects. Advantageously, new estimate statuses can be created and added to the view. FIG. 13 shows a proposal setup 430 view that allows new paragraphs to be added to a contract proposal. FIG. 14 shows a markup 440 view that lists the various price and/or cost markups to be used for various projects. The markup 440 view advantageously allows a user to edit existing markups and/or to add new markups.

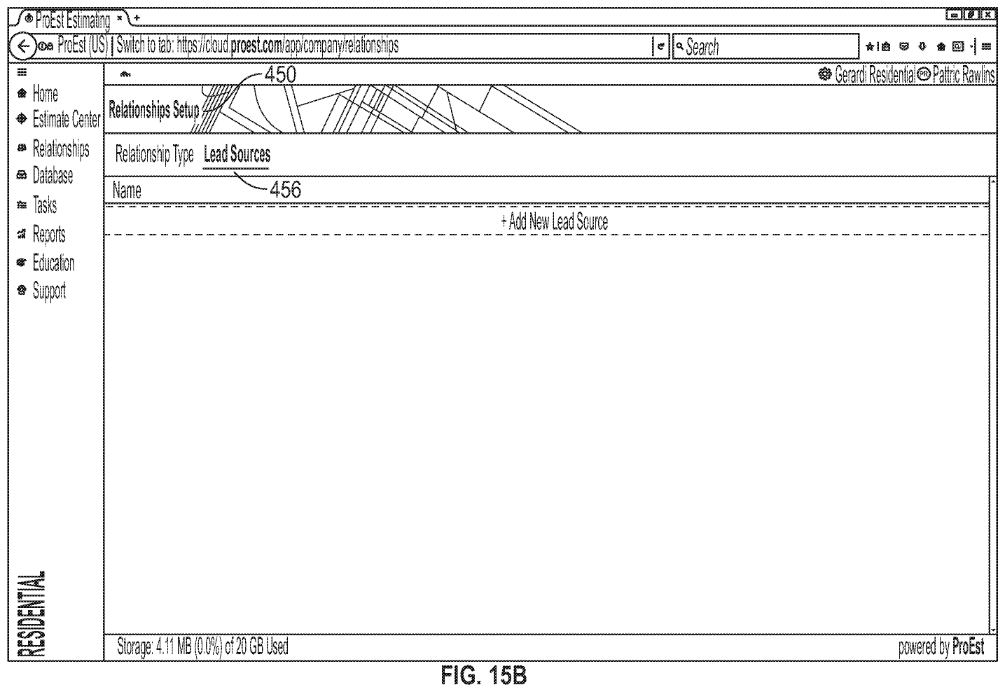

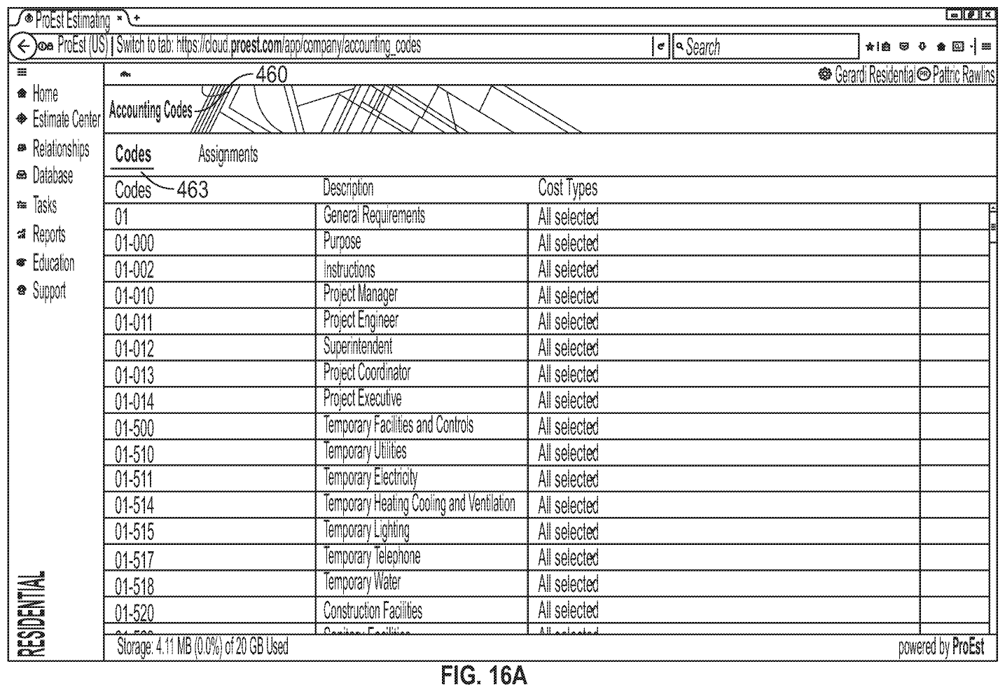

FIGS. 15A and 15B show relationship setup 450 views that allow a user to view existing relationships with individuals or entities and edit those relationships as well as create new relationships. Advantageously, different relationship types 453 can be managed, including clients 454 and leads 455 as shown in FIG. 15A. As shown in FIG. 15B, lead sources 456 may also be managed in the relationships setup 450 view.

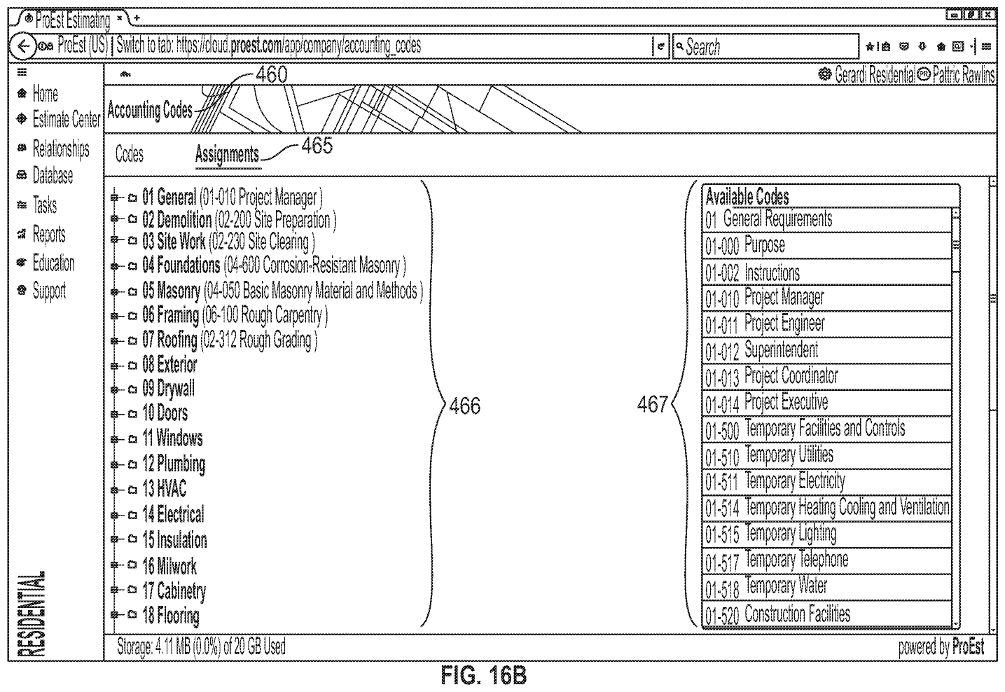

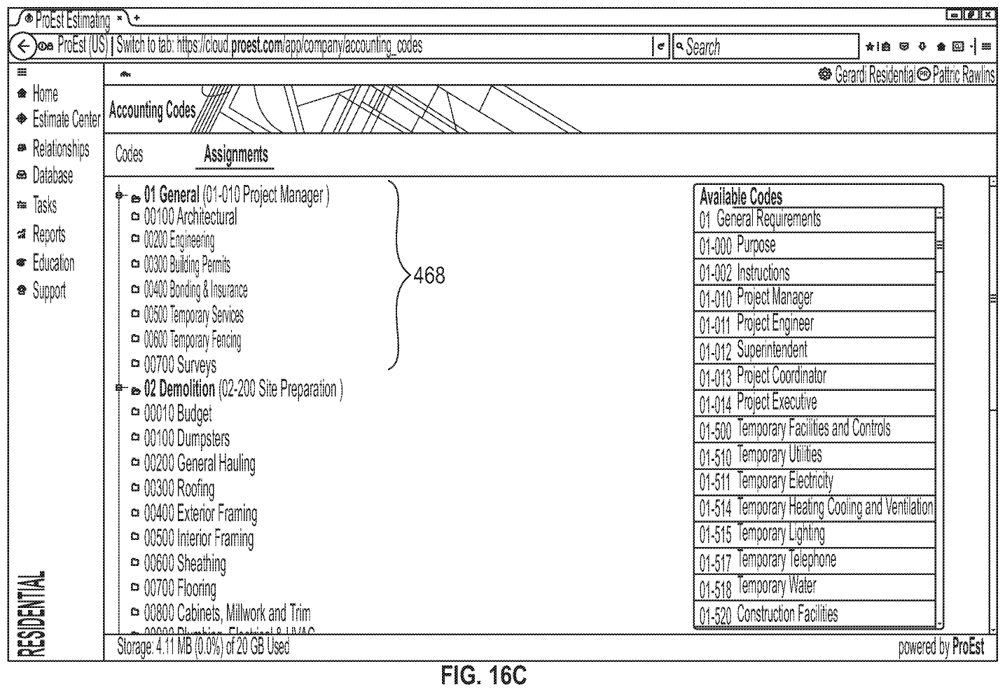

FIGS. 16A through 16C show accounting codes 460 views that list various accounting codes 463 and their corresponding descriptions and cost types. Accounting codes 463 can be edited and created using the accounting codes 460 views. In an assignments 465 view, as shown in FIG. 16B, each item type 467 may have plural items 468 in a database (e.g., a materials database from FIG. 6A) and each item 468 and/or item type 467 can be assigned to its corresponding accounting code 467 as shown in FIGS. 16C and 6B.

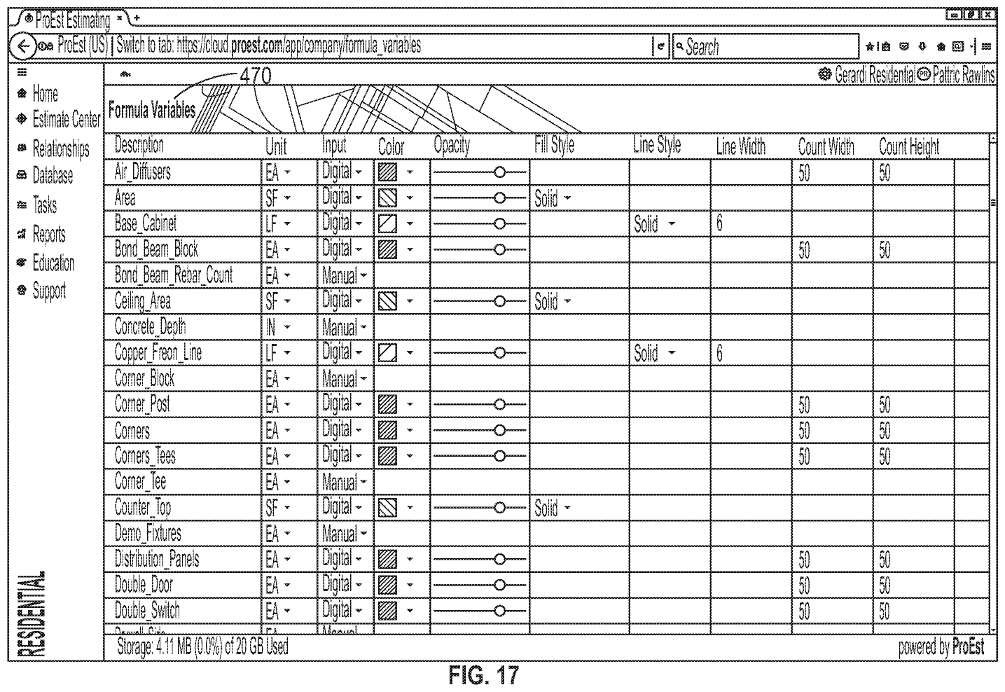

FIG. 17 shows a formula variables 470 view that lists various parameters that are used by the server 40, for example, when illustrating a takeoff that is created by a user.

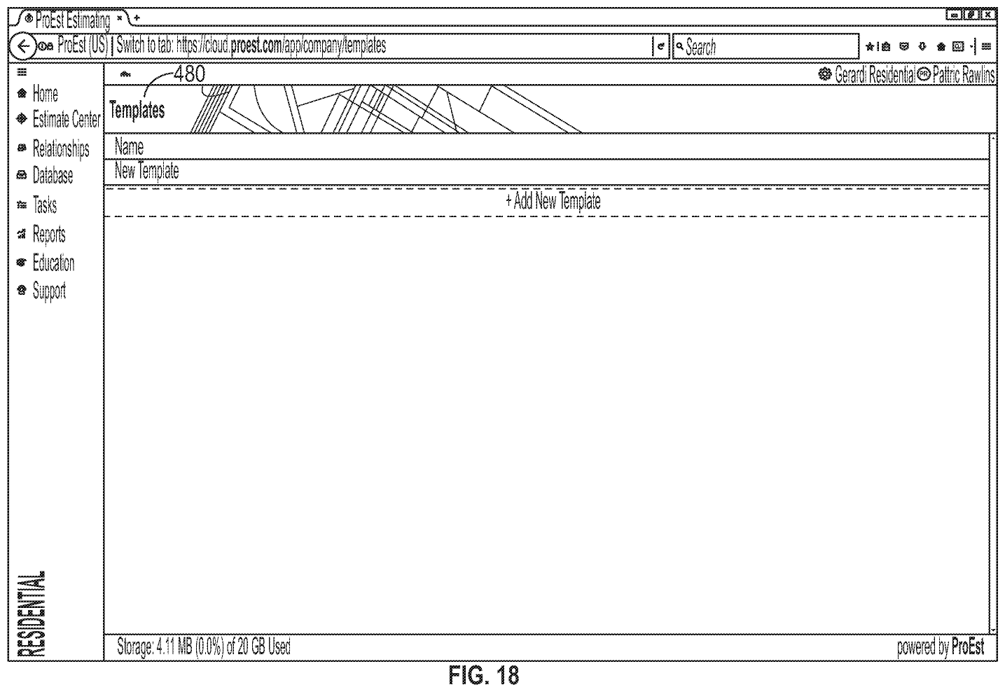

FIG. 18 shows a templates 480 view that lists one or more templates that can be used with the server 40.

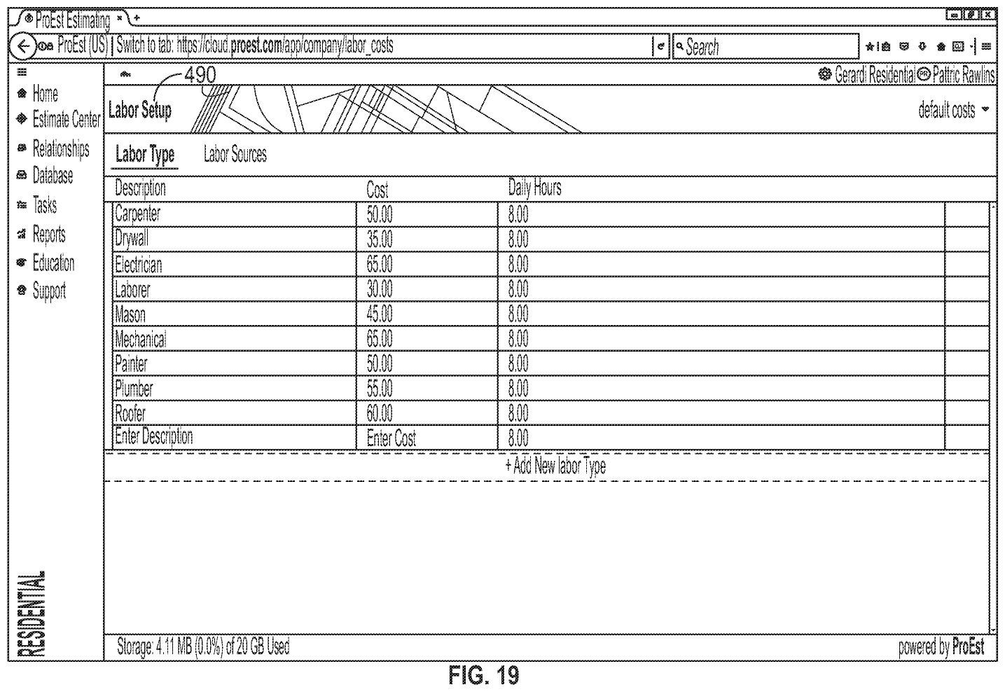

FIG. 19 shows a labor setup 490 view that lists a variety of different types of labor and labor sources along with the corresponding cost and the daily hours unit. For example, electrician labor costs $65 per hour with a daily hours unit of 8 hours per day.

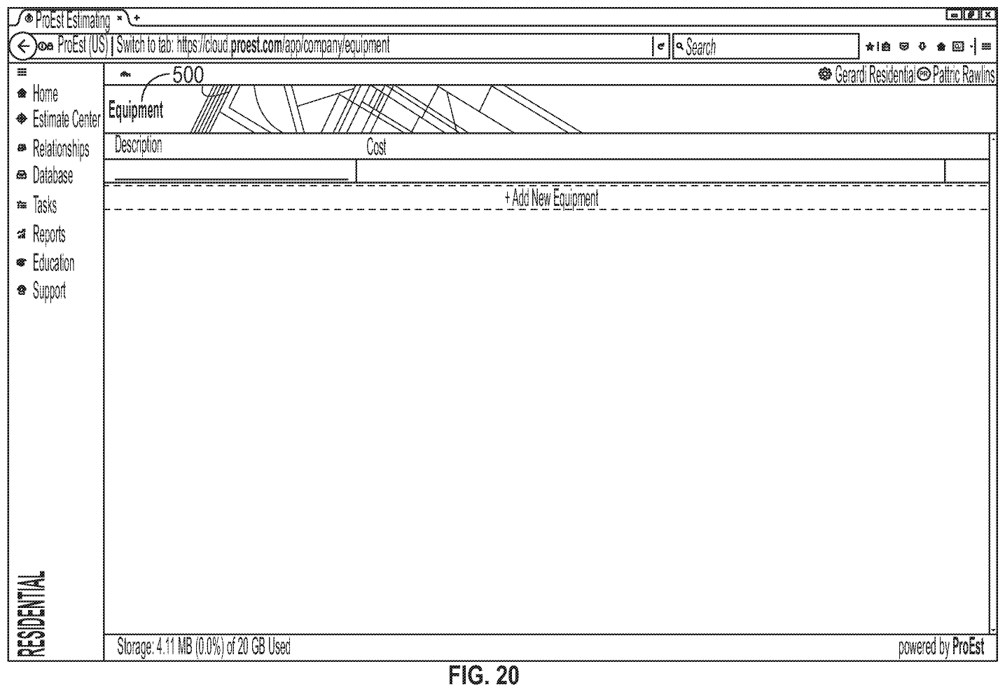

FIG. 20 shows an equipment 500 view that lists a variety of different types of equipment and a cost for each type of equipment. In one embodiment, the cost is an operating cost. In an alternative embodiment, the cost is an acquisition cost.

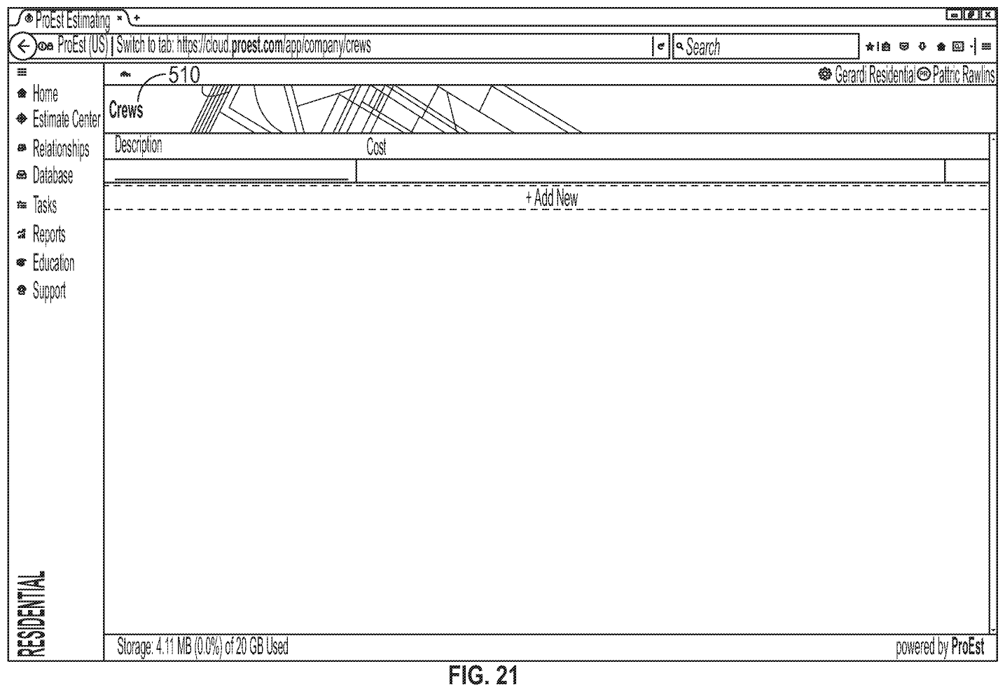

FIG. 21 shows a crews 510 view that lists a variety of different types of crews and a labor cost for each type of crew.

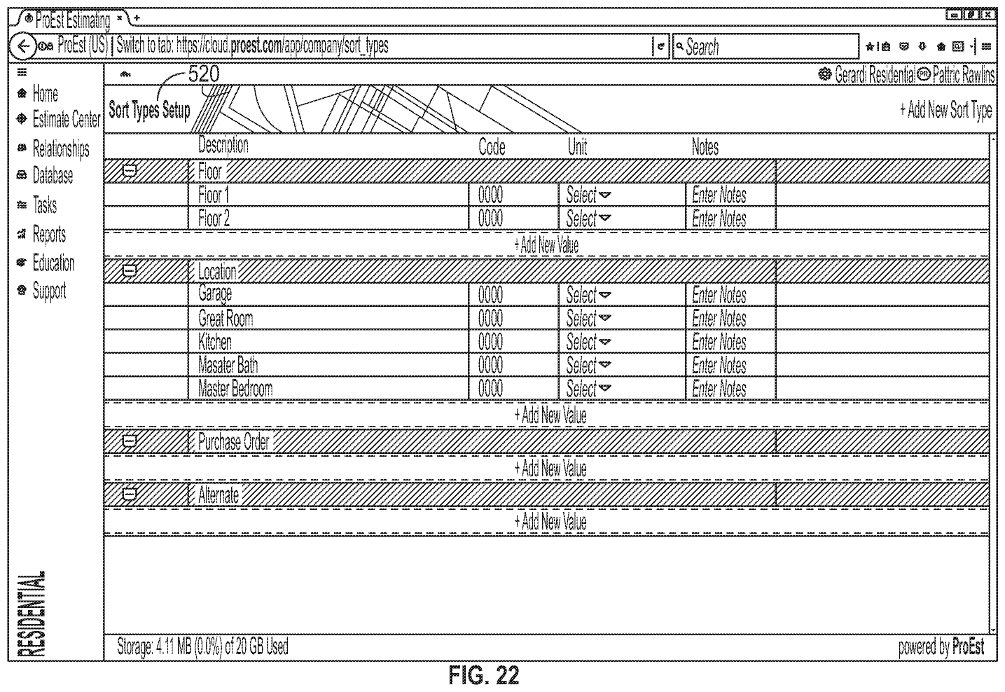

FIG. 22 shows a sort types setup 520 view that allows a user to configure the various estimate sort types as previously shown in FIG. 4E.

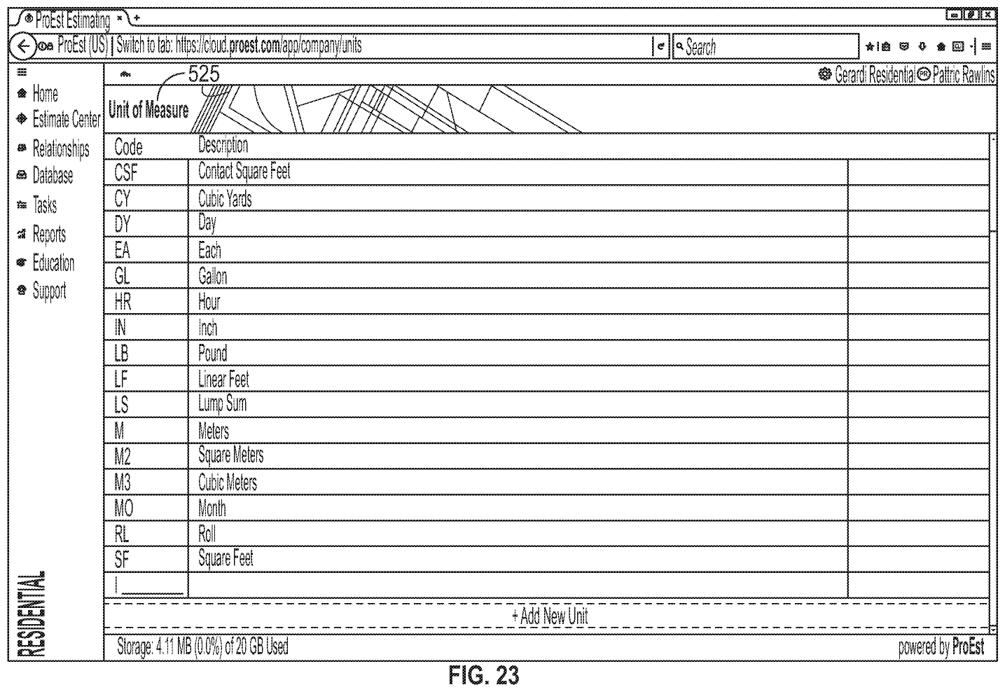

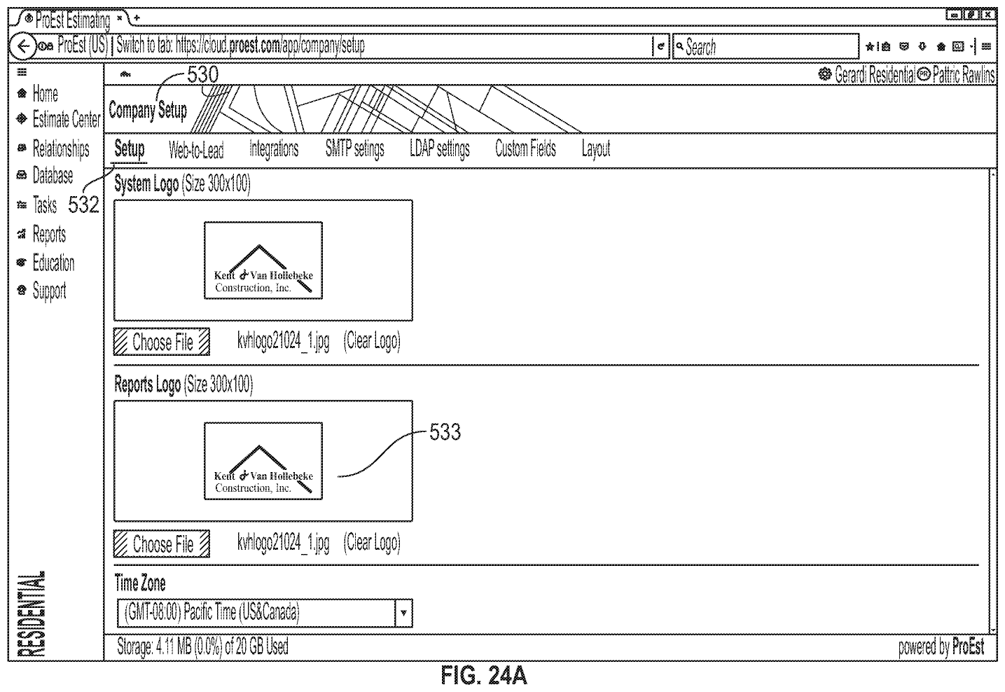

FIG. 23 shows a unit of measure 525 view that allows a user to configure the preferred unit of measurement to be used for various projects.

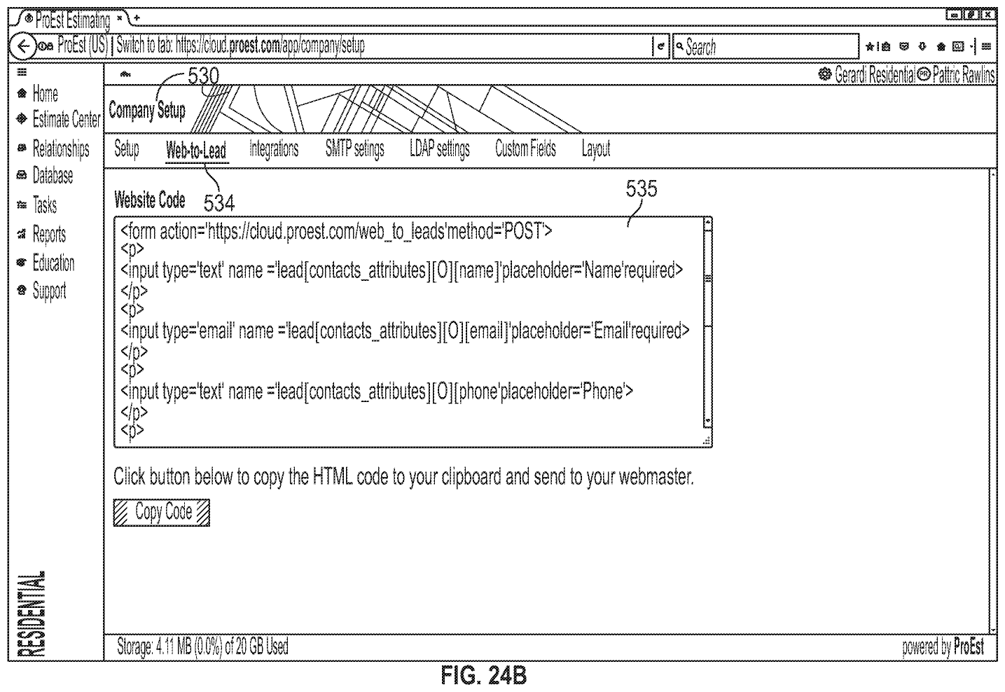

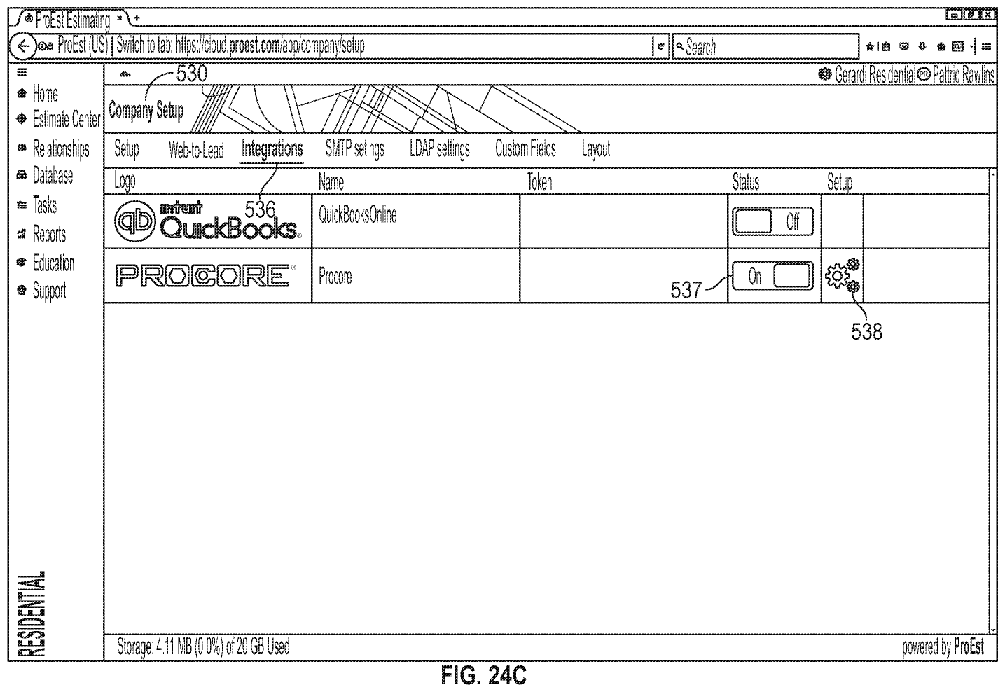

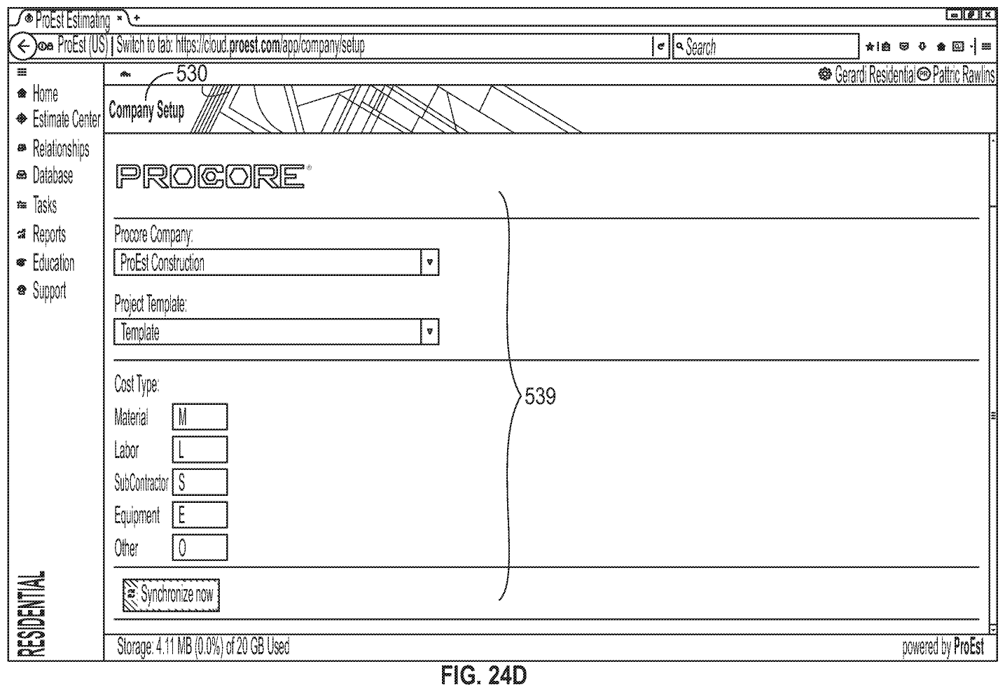

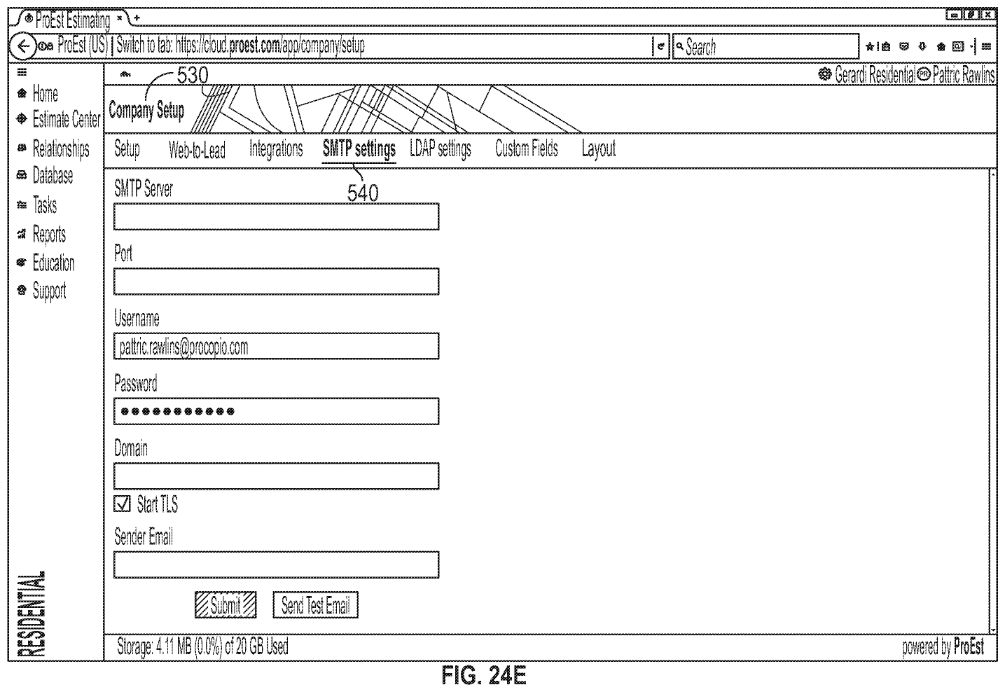

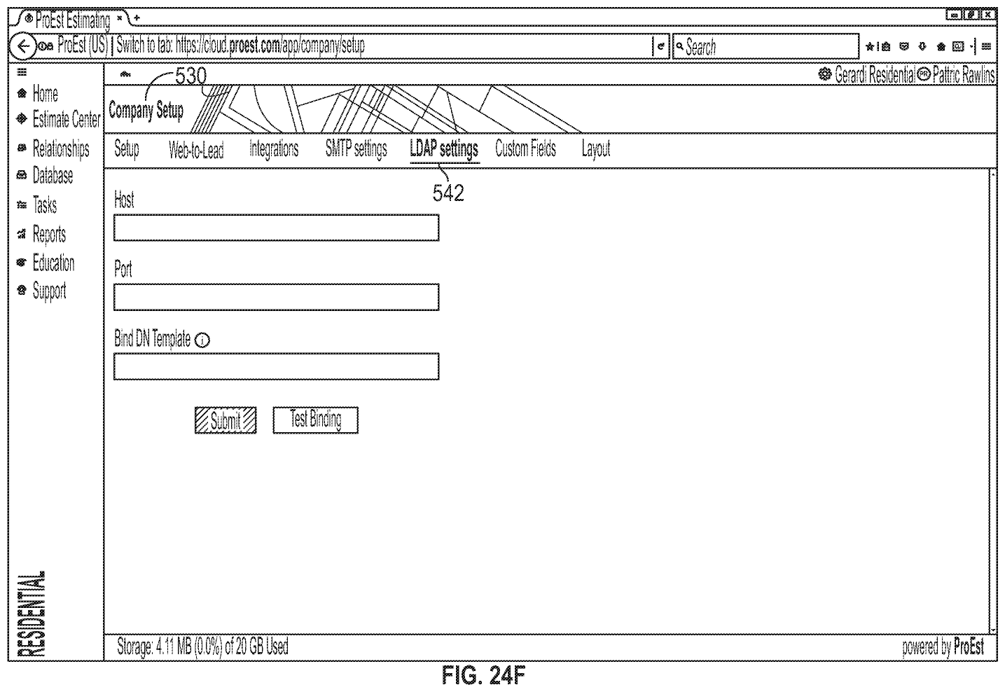

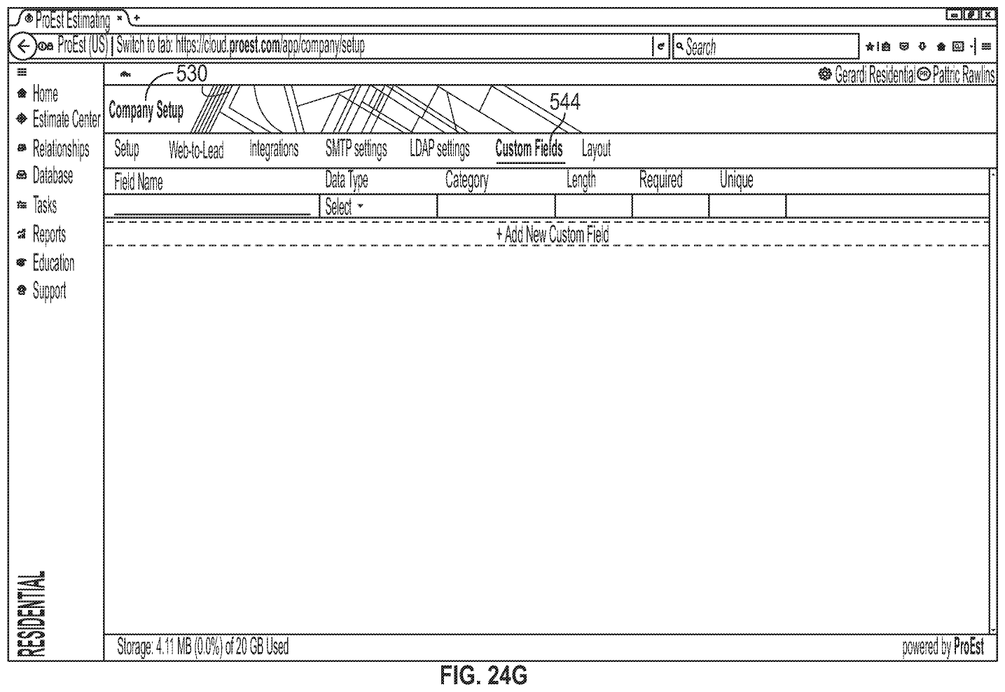

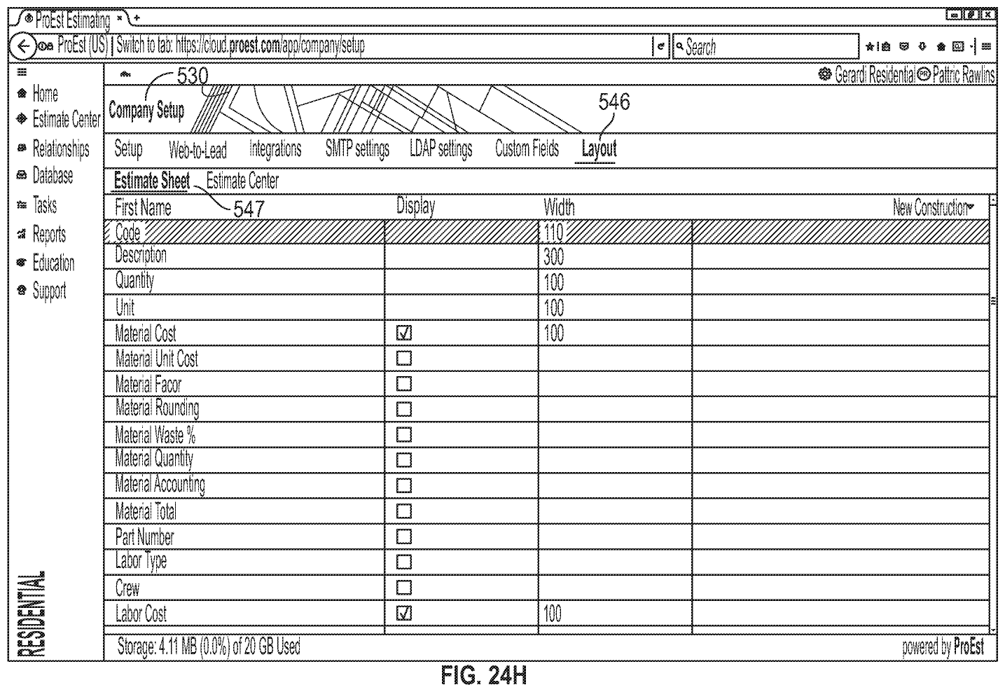

FIGS. 24A through 24I show various company setup 530 views that allow a user with appropriate privileges to create and edit information about a company account within the server 40. In FIG. 24A a setup 532 view includes the company logos 533 that can be included in system views and reports. The logos can advantageously be uploaded in the setup 532 view and the preferred time zone can be set. In FIG. 24B a web-to-lead 534 view is shown where website code 535 associated with the company account can be entered. In FIG. 24C an integrations 536 view is illustrated where companies can be identified and their respective status can be activated or deactivated using a toggle switch 537 and the company information can be setup by selecting a setup icon 538. In FIG. 24D the setup view is illustrated where company information can be entered into a user input 539 view.

In FIGS. 24E and 24F certain network access information can be provided via an SMTP settings 540 view and an LDAP settings 542 view and the information can be customized for a company account. In FIG. 24G a custom fields 544 view is illustrated that facilitates the use of custom fields that can be established for a company account. Finally, in FIGS. 24H and 24I a layout view 546 is provide that allows the layout of estimate sheets 547 and the estimate center 548 to be established for a company account.

FIG. 26 is a block diagram illustrating an example wired or wireless system 550 that may be used in connection with various embodiments described herein. For example the system 550 may be used as or in conjunction with a user device or a server device as previously described with respect to FIGS. 1 and 2. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A system comprising:
a non-transitory computer readable medium configured to store executable programmed modules;
a processor communicatively coupled with the non-transitory computer readable medium configured to execute programmed modules stored therein;
a user interface module stored in the non-transitory computer readable medium and configured to be executed by the processor, the user interfaced module configured to present information and one or more user input fields on a display of a user device and further configured to receive information via the one or more user input fields;
a workflow module stored in the non-transitory computer readable medium and configured to be executed by the processor, the workflow module configured to control the scheduling of tasks associated with a project and further configured to control assignment of tasks to one or more users;
a tasks module stored in the non-transitory computer readable medium and configured to be executed by the processor, the tasks module configured to present one or more tasks to a user, wherein the one or more presented tasks have been assigned to the user;
a costs module stored in the non-transitory computer readable medium and configured to be executed by the processor, the costs module configured to determine a cost associated with one or more items of material associated with the project, the costs module further configured to determine a cost association with one or more items of labor associated with the project;
a takeoffs module stored in the non-transitory computer readable medium and configured to be executed by the processor, the takeoffs module configured to receive input from a user identifying an area of a scaled diagram associated with the project and calculate one or more metrics associated with the area of the scaled diagram; and
an estimates module stored in the non-transitory computer readable medium and configured to be executed by the processor, the estimates module configured to determine an estimated cost associated with at least a portion of a project, wherein the estimated cost comprises a materials cost portion and a labor cost portion.

2. The system of claim 1, wherein the metric is one of a linear feet measurement, a square fee measurement, a volume measurement.

3. The system of claim 1, wherein the estimates module is further configured to automatically update one or more estimated costs in response to identifying a change in one or more metrics used to calculate the estimated cost.

4. The system of claim 1, further comprising a documents module stored in the non-transitory computer readable medium and configured to be executed by the processor, the documents module configured to receive and store one or more documents associated with the project.

5. The system of claim 1, wherein at least one of the one or more documents comprises a scaled diagram associated with the project.

6. The system of claim 1, further comprising a reports module stored in the non-transitory computer readable medium and configured to be executed by the processor, the reports module configured to generate one or more reports associated with the project and present one or more reports on a display of a user device.

7. The system of claim 1, further comprising an education module stored in the non-transitory computer readable medium and configured to be executed by the processor, the education module configured to present information on a display of a user device, the presented information related to how to use one or more modules of the system.

8. The system of claim 1, further comprising a bid day module stored in the non-transitory computer readable medium and configured to be executed by the processor, the bid day module configured to compare two or more estimates for a specific portion of the project.

9. The system of claim 1, further comprising an integrations module stored in the non-transitory computer readable medium and configured to be executed by the processor, the integrations module configured to establish communication via a data communication network with a third party software application and receive information from the third party software application and provide information to the third party software application.

10. An apparatus comprising at least one processor communicatively coupled with at least one non-transitory computer readable medium, wherein the processor is programmed to:
identify a plurality of tasks required to be completed to determine a construction project estimate;
generate a workflow comprising each of the identified plurality of tasks, wherein the workflow establishes relationships between at least two of the identified plurality of tasks such that a first of the at least two tasks must be completed prior to starting a second of the at least two tasks;
receiving an indication that each task of the plurality of tasks is complete; and
automatically generating a construction project estimate based on the completed plurality of tasks and material cost information and labor cost information corresponding to materials and labor associated with one or more of the plurality of tasks.

11. A computer implemented method, where one or more processors are programmed to perform steps comprising:
identify a plurality of tasks required to be completed to determine a construction project estimate;
generate a workflow comprising each of the identified plurality of tasks, wherein the workflow establishes relationships between at least two of the identified plurality of tasks such that a first of the at least two tasks must be completed prior to starting a second of the at least two tasks;
receiving an indication that each task of the plurality of tasks is complete; and
automatically generating a construction project estimate based on the completed plurality of tasks and material cost information and labor cost information corresponding to materials and labor associated with one or more of the plurality of tasks.

12. A non-transitory computer readable medium having stored thereon one or more sequences of instructions for causing one or more processors to perform steps comprising:
identify a plurality of tasks required to be completed to determine a construction project estimate;
generate a workflow comprising each of the identified plurality of tasks, wherein the workflow establishes relationships between at least two of the identified plurality of tasks such that a first of the at least two tasks must be completed prior to starting a second of the at least two tasks;
receiving an indication that each task of the plurality of tasks is complete; and
automatically generating a construction project estimate based on the completed plurality of tasks and material cost information and labor cost information corresponding to materials and labor associated with one or more of the plurality of tasks.
